(19) United States
(12) Patent Application Publication
(10) Pub. No.: US 2025/0252174 A1
(43) Pub. Date: Aug. 7, 2025

(54) VIRTUAL HOLOGRAPHIC VERIFICATION FOR WEBSITES

(71) Applicant: MIRRORTAB CORP., San Francisco, CA (US)

(72) Inventors: Brian Silverstein, San Carlos, CA (US); Amitaabh Malhotra, San Francisco, CA (US); Jack Tannenbaum, San Francisco, CA (US)

(73) Assignee: MIRRORTAB CORP., San Francisco, CA (US)

(21) Appl. No.: 19/070,908

(22) Filed: Mar. 5, 2025

Related U.S. Application Data
(60) Provisional application No. 63/550,752, filed on Feb. 7, 2024.

(51) Int. Cl. G06F 21/44

(52) U.S. Cl. CPC G06F 21/44

(57) ABSTRACT

Disclosed embodiments provide a framework for dynamically generating virtual holograms usable to verify the authenticity of a website or other web assets. In response to a request to access a website, a virtual machine service provider authenticates the website and generates a virtual hologram that can be used to verify the authenticity of the website. The virtual hologram encodes a time-based code that is updated at each timestep. The virtual hologram is provided in conjunction with the website to allow for scanning of the virtual hologram to verify the validity of the website.

### CROSS-REFERENCE TO RELATED APPLICATIONS

The present patent application claims the priority benefit of U.S. provisional patent application No. 63/550,752 filed Feb. 7, 2024, the disclosures of which are incorporated by reference herein.

### FIELD

The present disclosure relates generally to systems and methods for dynamically generating virtual holograms usable to verify the authenticity of a website or other web assets.

### SUMMARY

Disclosed embodiments provide a framework for dynamically generating virtual holograms usable to verify the authenticity of a website or other web assets. In response to a request to access a website, a virtual machine service provider authenticates the website and generates a virtual hologram that can be used to verify the authenticity of the website. The virtual hologram encodes a time-based code that is updated at each timestep. The virtual hologram is provided in conjunction with the website to allow for scanning of the virtual hologram to verify the authenticity of the website.

According to come embodiments, a computer-implemented method is provided. The computer-implemented method comprises detecting a request to access a website. The website is implemented on one or more web servers. The computer-implemented method further comprises authenticating the website. The website is authenticated based on a set of assets corresponding to the website. The computer-implemented method further comprises dynamically generating a virtual hologram corresponding to the website. The virtual hologram is dynamically generated according to a virtual hologram seed associated with the website and one or more parameters associated with the website. The computer-implemented method further comprises providing the virtual hologram. The virtual hologram is provided in real-time with the website. Further, when the virtual hologram is processed by an authentication device, the authentication device verifies that the website has been authenticated. The computer-implemented method further comprises detecting a change to the one or more parameters associated with the website. The computer-implemented method further comprises dynamically updating the virtual hologram corresponding to the website. The virtual hologram is dynamically updated according to the virtual hologram seed and the change to the one or more parameters.

In some embodiments, providing the virtual hologram further comprises obtaining the set of assets. The set of assets is used to implement the website. Providing the virtual hologram further comprises encoding the set of assets and the virtual hologram according to a data format to generate a data stream. When the data stream is received, the data stream is decoded to generate a graphical facsimile of the website and the virtual hologram.

In some embodiments, the virtual hologram is a Quick Response code.

In some embodiments, the virtual hologram encodes a set of signal instructions that, when executed, cause a computing device to transmit a unique wireless signal. Further, the unique wireless signal is configured according to the virtual hologram seed and the one or more parameters.

In some embodiments, the one or more parameters include a timestamp corresponding to a time when the request was detected.

In some embodiments, the virtual hologram is provided through an inline frame implemented on the website.

In some embodiments, the computer-implemented method further comprises transmitting a set of executable instructions that, as a result of being executed, cause an option to inspect the virtual hologram on the website to become disabled.

In some embodiments, the virtual hologram encodes a set of executable instructions that, when executed by the authentication device, cause the authentication device to request authentication information for authenticating a user of the authentication device. Further, the computer-implemented comprises dynamically generating a new virtual hologram corresponding to the authentication device. The new virtual hologram is generated according to the authentication information.

In some embodiments, the computer-implemented method further comprises receiving a one-time passcode associated with the virtual hologram and credential information associated with a user of the authentication device. The one-time passcode is extracted from the virtual hologram. The computer-implemented method further comprises allowing access to one or more elements associated with the website. The access is allowed based on authentication of the one-time passcode and the credential information.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The present disclosure is described in conjunction with the appended Figures:

FIG. 1 shows an illustrative example of an environment in which a virtual machine service provider dynamically generates a virtual hologram usable to allow for authentication of a website presented through a browser application in accordance with at least one embodiment;

FIG. 2 shows an illustrative example of an environment in which a virtual machine service provider automatically encodes the web Document Object Model (DOM) associated with a website and a virtual hologram to prevent exposure of the web DOM while providing a representation and method for authentication of the website to users in accordance with at least one embodiment;

FIG. 3 shows an illustrative example of an environment in which a virtual machine service provider dynamically generates and embeds onto a website a virtual hologram usable to allow for authentication of the website in accordance with at least one embodiment;

FIGS. 4A and 4B show an illustrative example of an environment in which a virtual machine service provider dynamically generates and embeds a virtual hologram onto an inline frame of a website for use in authenticating the website in accordance with at least one embodiment;

FIG. 5 shows an illustrative example of an environment in which a virtual machine service provider dynamically generates a virtual hologram that encodes executable instructions that, when executed by a computing device, causes the computing device to emit a wireless signal usable to authenticate a website in accordance with at least one embodiment;

FIG. 6 shows an illustrative example of an environment in which a browser extension application associated with a virtual machine service provider converts one or more keywords corresponding to a website to a Uniform Resource Identifier corresponding to a virtual machine instance through which the website can be accessed in accordance with at least one embodiment;

FIG. 7 shows an illustrative example of a process for encoding a document object model (DOM) corresponding to a website and a virtual hologram usable to authenticate the website into a data stream for presentation of the website and the virtual hologram in accordance with at least one embodiment;

FIG. 8 shows an illustrative example of a process for adding a virtual hologram to a website associated with an internet-based service for use in authenticating the website in accordance with at least one embodiment;

FIG. 9 shows an illustrative example of a process for authenticating a website through evaluation of encoded virtual hologram data from a presented virtual hologram in accordance with at least one embodiment;

FIG. 10 shows an illustrative example of a process for executing a browser extension application command and corresponding keywords to generate a request to access a website through a virtual machine instance in accordance with at least one embodiment; and

FIG. 11 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing a preferred examples of embodiment. It is understood that various changes can be made in the function and arrangement of elements without departing from the spirit and scope as set forth in the appended claims.

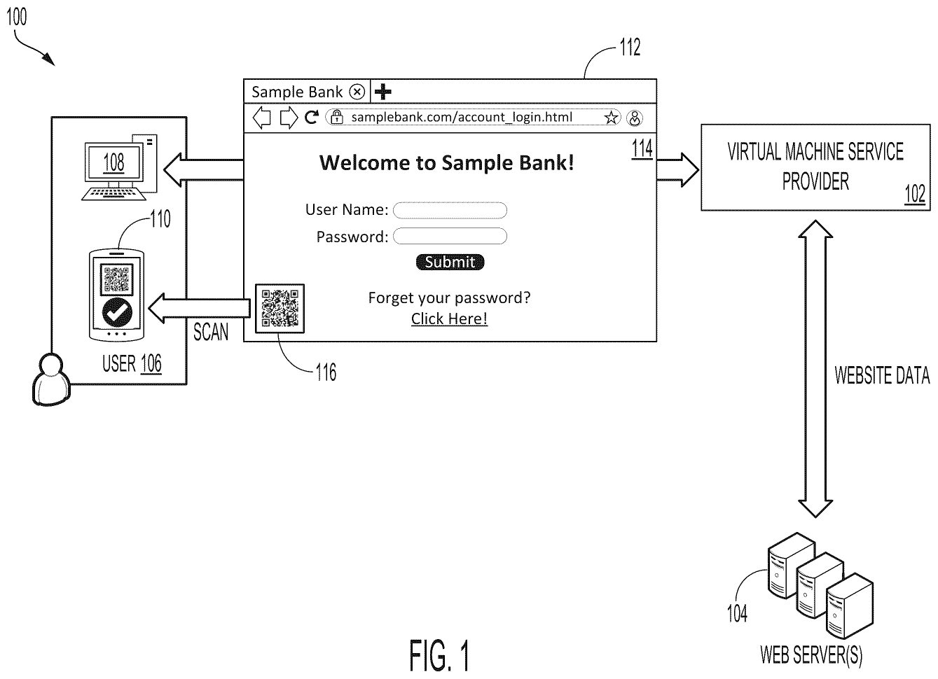

FIG. 1 shows an illustrative example of an environment 100 in which a virtual machine service provider 102 dynamically generates a virtual hologram 116 usable to allow for authentication of a website 114 presented through a browser application 112 in accordance with at least one embodiment. In the environment 100, an administrator of a website (e.g., website 114, etc.) may access a virtual machine service provider 102 to configure automatic encoding of the website for presentation to users (such as user 106) when these users submit requests to access the website. The virtual machine service provider 102 may include various computing resources (e.g., physical hosts, servers, mainframes, etc.) that may be configured to instantiate virtual machine instances onto virtual computer systems on behalf of different entities, such as users and website administrators.

In an embodiment, the virtual machine service provider 102 provides users and website administrators with various configuration options for a virtual environment through which a graphical facsimile of the website 114 may be presented. For instance, the virtual machine service provider 102 may provide various memory options for a virtual environment, where the amount of memory provided in each configuration option may correspond to the available functionality of the virtual environment. For instance, a configuration option that includes a greater amount of memory allocation may allow for a virtual environment that enables streaming of digital video and audio at a higher fidelity compared to a configuration option with less memory allocation. In some instances, rather than providing configuration options that specify computing specifications for a virtual environment, the virtual machine service provider 102 may provide configuration options that specify attributes that are specific to the virtual environment. For example, a particular configuration option may specify the capabilities of the virtual environment, such as the resolution available for digital video streaming and the like. In addition to providing memory options for the virtual environment, the virtual machine service provider 102 may further provide bandwidth, storage, and/or processor or vCPU options for its virtual environment. For instance, the virtual machine service provider 102 may provide one or more bandwidth (e.g., upload and/or download) options for the virtual environment.

In some instances, the virtual machine service provider 102 may allow a user or website administrator to define a set of configuration requirements for the virtual environment. For instance, a user or website administrator may specify that the virtual environment is to be supported by a virtual machine instance having a minimum amount of random-access memory (RAM), a minimum number of virtual central processing units (vCPUs), minimum storage capacity, a minimum amount of available bandwidth, and the like. Further, a user or website administrator may specify which browser application is to be implemented within the virtual environment. For instance, a user or website administrator may specify that the virtual environment is to implement a Google Chrome™ browser application as opposed to Microsoft Edge®, Mozilla Firefox®, or any other available browser application. Alternatively, the user or website administrator may specify that it is agnostic as to which browser application is implemented within the virtual environment so long as the minimum configuration requirements are satisfied.

In an embodiment, the virtual machine instance utilized to implement the virtual environment is instantiated such that only the virtual environment is accessible to any authorized users. For instance, the virtual machine instance may include an operating system, a browser application, and a variety of other applications that may be executed to support the browser application and any other functionality required for the implementation of the virtual environment. The virtual machine service provider 102 may restrict access to the virtual machine instance instantiated for the virtual environment such that users may only be able to access the virtual environment. This may prevent users from accessing the operating system or any other application or functionality of the virtual machine instance not related to the virtual environment.

In an embodiment, the virtual machine instance utilized to implement the virtual environment is instantiated such that certain functionality of the virtual environment is restricted, prohibited, or otherwise inaccessible to users. For example, through the virtual environment, users may be prohibited from installing any browser extensions onto a virtual browser application implemented within the virtual environment. As another illustrative example, users may be prohibited from accessing any developer tools or other tools usually implemented by the virtual browser application that allow users to inspect and/or modify any presented assets (e.g., HyperText Markup Language (HTML) code, Cascading Style Sheets (CSS), JavaScript code, applets, etc.). Further, as another illustrative example, the virtual machine service provider 102 may prohibit users from being able to inspect any web element or other element presented or otherwise available through the virtual browser application implemented within the virtual environment.

In an embodiment, the virtual machine instance includes a set of software containers that may execute in isolation from each other (e.g., a software container may have an isolated view of a file system, etc.). For instance, a virtual browser application presented via the virtual environment may be executed on a software container isolated from other processes operating within the virtual machine instance. Further, the virtual machine instance may implement a software container for the operating system, a software container that serves as a storage volume for downloads obtained via the virtual browser application, a software container for personal settings, and the like. The software container used to implement the virtual browser application may be configured to only have limited access to resources available via other software containers of the virtual machine instance. Thus, the software container may be executed to have access to only certain resources from the computing resources allocated for the virtual machine instance. Due to this isolation, a user of the virtual environment may only be able to access and interact with the virtual browser application. This may prevent users from accessing the operating system, file systems, and other resources associated with the virtual machine instance, providing an additional layer of security for the virtual environment.

In an embodiment, in addition to execution of virtual environments, a virtual machine instance can be implemented to automatically, and in real-time, encode the web DOM associated with a particular website 114 into a data stream that obfuscates the web DOM associated with the particular website but that may be decoded by computing devices (such as computing device 108 utilized by a user 106) to allow for presentation of a graphical facsimile of the website 114. This graphical facsimile of the website 114 may be presented to users without exposure of the web DOM associated with the particular website 114, as the graphical facsimile of the website 114 is generated using an alternative data structure that does not include the web DOM associated with the particular website 114. In an embodiment, the virtual machine instance includes one or more software containers that include one or more applications or programs that can automatically encode the web DOM associated with a particular website 114 and generate a graphical facsimile of the particular website 114 in real-time that may be provided to users attempting to access the particular website 114.

In an embodiment, the virtual machine instance, through the one or more software containers, encodes the web DOM associated with the particular website using one or more Web Real-Time Communication (WebRTC) protocols or through a Virtual Network Computing (VNC) protocol into a series of pixels. The virtual machine instance may transmit a binary data stream that includes these pixels to a client (e.g., the computing device 108 associated with a requesting user 106, etc.), which may decode the binary data stream to compile the set of pixels into the graphical facsimile of the particular website 114 on the client, such as through a browser application 112. Since the particular website 114 is graphically represented using a set of pixels rather than through the web DOM associated with the particular website 114, inspection of the web DOM associated with the particular website 114 is prevented. For instance, because the graphical facsimile of the particular website 114 is generated through decoding of binary data streams from the virtual machine instance, a DOM inspector may be unable to process these binary data streams to inspect the web DOM associated with the particular website 114.

In an embodiment, when an administrator of a particular website 114 configures a virtual machine instance to serve as a proxy of the particular website 114 in order to encode the web DOM associated with the particular website 114 into a graphical facsimile of the particular website 114 or users, the virtual machine service provider 102 updates one or more Domain Name System (DNS) servers to map the Uniform Resource Identifier (URI) associated with the particular website 114 with an Internet Protocol (IP) address corresponding to the virtual machine instance. For example, while the data (e.g., web DOM, assets, etc.) associated with a particular website 114 may reside within one or more web servers 104 maintained by the administrator of the particular website 114, the URI corresponding to the particular website 114 may be mapped to an IP address associated with the virtual machine instance implemented by the virtual machine service provider 102 as opposed to an IP address associated with the one or more web servers 104. Further, the virtual machine instance may be configured to automatically access the one or more web servers 104 in response to a request to access the website to obtain the web DOM and other assets associated with the website for encoding into the graphical facsimile of the website 114. Thus, if a user 106 enters, through a browser application implemented on their computing device 108, the URI corresponding to the particular website 114, the user 106 may be automatically directed to the virtual machine instance implemented by the virtual machine service provider 102 as opposed to the one or more web servers 104 that maintain the web DOM and other assets associated with the particular website 114.

When a user 106, through a browser application 112 implemented on their computing device 108, submits a request to access the website, the browser application 112 may transmit a request to the one or more DNS servers to obtain the IP address corresponding to the website. Accordingly, in response to the request from the browser application 112, the one or more DNS servers may return the IP address of the virtual machine instance. Using this IP address, the browser application 112 may transmit a request to the virtual machine instance to access the website. In response to the request to access the website, the virtual machine instance may automatically, and in real-time, query the one or more web servers 104 associated with the website 114 to obtain the web DOM and any other assets that may be used to render the website 114. The virtual machine instance may automatically process the web DOM and the other assets to generate a graphical facsimile of the website 114 that may be streamed to the user 106 in response to their request. For instance, if using a default encoding mechanism (e.g., one or more WebRTC protocols, a VNC protocol, etc.), the virtual machine instance may encode one or more portions of the web DOM associated with the particular website 114 into individual pixels that may be pushed or transmitted in a binary stream to the browser application 112. Alternatively, if the virtual machine service provider 102 implements a custom encoder for encoding of the one or more portions of the web DOM associated with the particular website 114 for delivery of the graphical facsimile of the website 114 to the user 106, the virtual machine instance may process the web DOM associated with the particular website 114 using the custom encoder to generate an encoding in a data format that may be compressed, encrypted, and transmitted to the browser application 112 for presentation of a graphical facsimile of the website 114.

As the virtual machine instance encodes the web DOM and the various assets associated with the website 114 according to either the default encoding method (e.g., one or more WebRTC protocols, a VNC protocol, etc.) or the custom encoding method defined by the virtual machine service provider 102, the virtual machine instance may push or transmit, in real-time, a data stream that includes the encoded graphical facsimile of the website 114. The browser application 112 may automatically, and in real-time, decode the encoded graphical facsimile of the website 114 and present the graphical facsimile of the website 114. The graphical facsimile of the website 114 may appear identical to the original website with some notable exceptions. For example, if the user 106 accesses, through the browser application 112, a browser menu corresponding to the presented graphical facsimile of the website 114, the option to inspect the website 114 may be disabled such that the user 106 is prohibited from inspecting the website 114. For instance, since the website 114 presented through the browser application 112 is a graphical facsimile of the website 114, the browser application 112 may automatically disable the option to inspect the website 114. In some instances, in addition to pushing or transmitting the data stream that includes the encoded graphical facsimile of the website 114, the virtual machine instance may transmit executable instructions to the browser application 112 to disable this option to inspect the website 114.

In an embodiment, the virtual machine instance further encodes a virtual hologram 116 that can be used to verify that the website 114 is authentic and originated from vetted web servers 104. The virtual hologram 116, in some examples, is a machine-readable label that encodes one or more characteristics or parameters associated with the website 114 (e.g., the name of the internet-based service associated with the website 114, the URI corresponding to the website 114, country of registration, website domain age, etc.). The virtual hologram 116 may further encode a URI corresponding to a website implemented by the virtual machine service provider 102 and through which the user 106 may obtain additional information regarding the authenticity of the website 114.

In an embodiment, the virtual hologram 116 additionally encodes a one-time password (OTP) or other time-based code that may be used to authenticate the virtual hologram 116 and the corresponding website 114 for which the virtual hologram 116 is dynamically generated. The OTP or other time-based code may be generated by the virtual machine service provider 102 using a virtual hologram seed that is generated or provisioned when the administrator of a particular website 114 configures the virtual machine instance that is to serve as a proxy of the particular website 114 and that encodes one or more portions of the web DOM associated with the particular website 114 into individual pixels that are pushed or transmitted in a data stream to the browser application 112. In an embodiment, the virtual hologram seed is a static value or cryptographic key that, along with a timestamp corresponding to a current time, may be used as input to a hash function or other cryptographic algorithm to generate unique OTPs for the website 114. Example hash functions and cryptographic algorithms include, but are not limited to, Message-Digest version 5 (MD5) algorithm, Secure Hash Algorithm 1 (SHA-1), any of the hash functions included in the SHA-2 suite, and the like.

As illustrated in FIG. 1, the virtual hologram 116 may be implemented as a Quick Response (QR) code that encodes the one or more characteristics/parameters associated with the website 114, the URI corresponding to the website implemented by the virtual machine service provider 102 for verifying the authenticity of the website 114, and the OTP or other time-based code. In some instances, the virtual hologram 116 may include an image corresponding to the virtual machine service provider 102 and/or the internet-based service associated with the website 114. In some instances, the virtual hologram 116 may be implemented using any form of one- or two-dimensional code that can be used to encode information and/or executable instructions (e.g., high-capacity color barcodes, NexCode, ShotCode, Qode, Data Matrix, CrontoSign, Aztec Code, barcodes, etc.).

In an embodiment, the virtual hologram 116 can be implemented using text-based sequences, whereby the virtual hologram 116 is presented on the website 114 as a sequence of alphanumeric characters, words, sentences, hashes, and the like. These characters may be dynamically updated at the initial time for a time interval or timestep corresponding to the present time. In some instances, the virtual hologram 116 may be implemented using a color-based coding sequence, whereby the virtual machine service provider 102, using a virtual hologram seed corresponding to the website 114, may generate a virtual hologram 116 that comprises a series of colors in a one-dimensional or two-dimensional format. This series of colors may be dynamically updated at each new time interval or timestep such that colors presented on the website 114 and serving as the virtual hologram 116 may be dynamically updated at each new time interval or timestep. In some instances, the virtual hologram 116 may implemented using a light-based sequence, whereby a portion of the website 114 corresponding to the virtual hologram 116 may flash an image, a color, a light, and the like according to a time-based pattern defined through the virtual hologram seed for the website 114. This time-based pattern may change according to the virtual hologram seed at each time interval or timestep corresponding to the present time. This light-based sequence may be recorded by the application on the user's mobile device 110 or other authentication device to obtain the encoded OTP or other time-based code that may be used to authenticate the website 114.

In some instances, the virtual hologram 116 may be implemented through other sensory techniques. For example, the virtual hologram 116 may be implemented using sound-based sequences, wherein interaction with an icon, button, or other interaction element associated with the virtual hologram 116 on the website 114 may cause the computing device 108 to produce an audial signal that may serve as the virtual hologram 116 and encodes the OTP or other time-based code. In an embodiment, the audial signal is generated through data-over-audio technology, such as that provided by ultrasonic data transmission technology (e.g., LISNR®, etc.). For instance, the virtual hologram seed used for the creation of the audial signals that are to serve as the virtual hologram 116 may be generated using a tone file that may be used to generate ultrasonic audial signals that encode the OTP or other time-based code that may be used to authenticate the website 114. These audial signals may be transmitted using standard speaker systems, such as a speaker implemented on the computing device 108. Further, these audial signals may be configured to be detectable using standard microphones, such as a microphone implemented on the mobile device 110 or other authentication device. In some instances, the virtual machine service provider 102, through the application implemented on the user's mobile device 110 or other authentication device, can provide a software development kit (SDK) that may be implemented to process these audial signals. For example, the application executed on the mobile device 110 or other authentication device may implement this SDK to demodulate any audial signals broadcast by the computing device 108 in response to selection of the icon, button, or other interaction element associated with the virtual hologram 116 on the website 114.

The user 106, using a mobile computing device 110, may scan the virtual hologram 116 presented through the browser application 112 executed on their computing device 108 to determine whether the presented website 114 has been vetted by the virtual machine service provider 102 and is authentic. For instance, when the user 106 uses their mobile computing device 110 to scan the virtual hologram 116, the mobile computing device 110 may automatically use the URI encoded in the virtual hologram 116 and corresponding to a website implemented by the virtual machine service provider 102 to access the website (such as through a browser application installed on the mobile computing device 110). The mobile computing device 110 may further extract from the virtual hologram 116, the one or more characteristics or parameters associated with the website 114 and the OTP or other time-based code that may be used to authenticate the virtual hologram 116. The mobile computing device 110 may transmit the extracted characteristics/parameters associated with the website 114 and the OTP or other time-based code to the website implemented by the virtual machine service provider 102 for authentication.

In some instances, the virtual machine service provider 102 may provide an application that may be installed and executed on the mobile computing device 110 and that may be used to determine whether the presented website 114 has been vetted by the virtual machine service provider 102 and is authentic. In one illustrative example, the user 106 may execute the application on their mobile computing device 110, which may automatically engage one or more integrated or peripheral devices (e.g., a camera, a scanner, etc.) associated with the mobile computing device 110 in order to scan the presented virtual hologram 116. In some instances, the virtual hologram 116 may encode executable instructions that, when scanned by the mobile computing device 110, may cause the mobile computing device 110 to execute the application associated with the virtual machine service provider 102. In an embodiment, the application transmits the extracted characteristics/parameters associated with the website 114 and the OTP or other time-based code to the virtual machine service provider 102 through one or more application programming interfaces (APIs) associated with the virtual machine service provider 102.

In response to receiving the OTP or other time-based code and the characteristics/parameters associated with the website 114, the virtual machine service provider 102 may determine whether the OTP or other time-based code is valid. For instance, using the characteristics/parameters associated with the website 114, the virtual machine service provider 102 may identify the website 114 for which the virtual hologram 116 was created. Using the known URI corresponding to the website 114, the virtual machine service provider 102 may query a virtual hologram seed datastore to identify the virtual hologram seed associated with the website 114. Using the identified virtual hologram seed and a timestamp corresponding to the time at which the virtual hologram 116 was scanned, the virtual machine service provider 102 may dynamically generate the expected OTP or other time-based code for the website 114 at the particular time at which the virtual hologram 116 was scanned. If the received OTP or other time-based code does not match the expected OTP or other time-based code for the website 114, the virtual machine service provider 102 may determine that the virtual hologram 116 being presented is not valid and, thus, the website 114 cannot be authenticated.

If the virtual machine service provider 102 determines that the virtual hologram 116 is not valid, the virtual machine service provider 102 may provide a notification to the user 106 to indicate that the website 114 could not be authenticated. For example, if the user 106 submitted the OTP or other time-based code and the website characteristics/parameters through the website implemented by the virtual machine service provider 102 for authentication of a presented website 114, the virtual machine service provider 102 may update an interface (such as a graphical user interface (GUI)) associated with the website implemented by the virtual machine service provider 102 to indicate that the presented website 114 could not be authenticated. As another illustrative example, if the OTP or other time-based code and the website characteristics/parameters were transmitted by an application through one or more APIs to the virtual machine service provider 102, the virtual machine service provider 102 may transmit, through the one or more APIs, a response to the application with an indication that the website 114 could not be authenticated. The application may accordingly update an interface (such as a GUI) implemented by the application to provide the indication to the user 106.

In an embodiment, if the virtual machine service provider 102 determines, based on the comparison of the provided OTP or other time-based code to the expected OTP or other time-based code, that the website 114 is authentic, the virtual machine service provider 102 can transmit a notification to the user 106 to indicate that the website 114 is authentic and legitimate. For instance, if the request to authenticate the website 114 was submitted through the website provided by the virtual machine service provider 102, the virtual machine service provider 102 may update an interface associated with this website to indicate that the website 114 is authentic and legitimate. As another illustrative example, if the request to authenticate the website 114 was submitted by an application installed on the mobile computing device 110, through one or more APIs, the virtual machine service provider 102, through these one or more APIs, may transmit a notification to the application to indicate that the website 114 has been authenticated and is legitimate. Accordingly, the application may update an interface (e.g., GUI) implemented by the application to present an indication that the website 114 has been authenticated by the virtual machine service provider 102 and is authentic.

In an embodiment, the virtual hologram 116 can be presented on the website 114 through an inline frame that, when executed, is configured to retrieve the virtual hologram 116 from the virtual machine service provider 102. For instance, if the user 106, through the browser application 112, submits a URI corresponding to the website 114 and the web DOM and other assets that may be used to render the website 114 are provided by the one or more web servers 104 directly to the browser application 112, the browser application 112 may use the web DOM and other assets to render the website 114. In an embodiment, if the website 114 includes an inline frame through which the virtual hologram 116 may be presented, the browser application 112 may process the URI included in the inline frame to submit a request to the virtual machine service provider 102 to obtain a virtual hologram 116 that may be presented on the website 114 and usable to authenticate the website 114. The request, in some instances, may include the URI associated with the website 114 as well as any other characteristics or parameters associated with the website 114 that may be used to authenticate the website 114 (e.g., the name of the internet-based service associated with the website 114, country of registration, website domain age, etc.).

In response to the request from the browser application 112, the virtual machine service provider 102 may evaluate the URI associated with the website 114, as well as any other provided characteristics or parameters associated with the website 114, to determine whether the website 114 is legitimate. For instance, if the URI associated with the website 114 and/or any other provided characteristics or parameters associated with the website 114 are suspicious in nature (e.g., the website 114 is known to include malware, the website 114 includes interaction elements that may lead to the installation of malware, the website 114 is tied to a suspicious entity, the website 114 is a phishing site, etc.), the virtual machine service provider 102 may automatically reject the request to generate and present a virtual hologram 116 through the inline frame on the website 114. Accordingly, as a result of the rejection of the request, the website 114 may be presented through the browser application 112 without the virtual hologram 116. In some instances, in place of the virtual hologram 116, the virtual machine service provider 102 may provide, through the inline frame, an indication that the website 114 could not be authenticated. This may warn the user 106 that the website 114 may not be legitimate or otherwise safe to use.

In some instances, if the virtual machine service provider 102 determines that the website 114 is not legitimate, the virtual machine service provider 102 may determine whether there is an analogous legitimate website that can be identified. For example, the virtual machine service provider 102 may process the URI associated with the website 114 against a repository of known URIs for legitimate websites to determine whether a legitimate website can be identified. In some embodiments, the virtual machine service provider 102 can process the other provided characteristics or parameters associated with the website 114 to identify any elements associated with a legitimate entity (e.g., bank, retailer, etc.) that are being spoofed or misappropriated for a nefarious purpose. Based on this identification of elements associated with a legitimate entity, the virtual machine service provider 102 may identify a legitimate website that the user 106 may be re-directed to via the browser application 112 or a virtual machine instance through which the legitimate website may be rendered and presented to the user 106 through the browser application 112.

In an embodiment, the virtual machine service provider 102 implements and dynamically trains a machine learning algorithm or artificial intelligence to identify the elements associated with legitimate entities from provided characteristics or parameters associated with different websites (such as the website 114) and/or to identify legitimate websites based on evaluation of suspicious URIs associated with these different websites. The machine learning algorithm or artificial intelligence may be trained using supervised training techniques. For instance, a dataset of web assets (including any corresponding characteristics or parameters) associated with a set of sample websites, URIs or other network addresses associated with the set of sample websites, known elements associated with legitimate entities, and known URIs corresponding to these legitimate entities can be selected for training of the machine learning algorithm or artificial intelligence. The machine learning algorithm or artificial intelligence may be evaluated to determine, based on the sample inputs supplied to the machine learning algorithm or artificial intelligence, whether the machine learning algorithm or artificial intelligence is producing accurate URIs corresponding to the legitimate entity that the suspicious entity may be trying to spoof or otherwise imitate. Based on this evaluation, the machine learning model may be modified to increase the likelihood of the machine learning algorithm or artificial intelligence generating the desired results.

The machine learning algorithm or artificial intelligence employed by the virtual machine service provider 102 may further be dynamically trained by soliciting feedback from different users. For instance, if the virtual machine service provider 102 re-directs a user to a legitimate website that is wholly unrelated to the elements associated with a legitimate entity presented on the website 114, the user may provide feedback to the virtual machine service provider 102 indicating that the website the user was re-directed to was not relevant or otherwise not useful to the user. The virtual machine service provider 102 may use this feedback to modify one or more coefficients or hyperparameters of the machine learning algorithm or artificial intelligence to better identify a legitimate website associated with the elements associated with the legitimate entity being spoofed or imitated via the website 114. Similarly, a user may provide feedback regarding the ability of the machine learning algorithm or artificial intelligence to identify suspicious URIs. This feedback may be used to update the machine learning algorithm or artificial intelligence to better identify suspicious URIs and, in response, identify legitimate URIs corresponding to legitimate entities.

In an embodiment, if the virtual machine service provider 102 determines that the website 114 cannot be authenticated, the virtual machine service provider 102 may re-direct the user 106, through the browser application 112, to a virtual environment implemented by the virtual machine service provider 102. Through the virtual environment, the virtual machine service provider 102 may encode the web DOM associated with the legitimate website using one or more WebRTC protocols or through a VNC protocol into a series of pixels. The virtual machine service provider 102 may transmit a binary data stream that includes these pixels to the computing device 108 associated with the user 106, which may decode the binary data stream to compile the set of pixels into the graphical facsimile of the legitimate website through the browser application 112. Additionally, through this data stream, the virtual machine service provider 102 may encode the virtual hologram 116, which the user 106 may use to verify that the legitimate website being graphically represented through the browser application 112 is legitimate.

In an embodiment, if the virtual machine service provider 102 determines, based on the URI of the website 114 and the other provided characteristics or parameters associated with the website 114, that the website 114 is legitimate, the virtual machine service provider 102 may dynamically generate, according to the process described above, a virtual hologram 116 that may be presented through the inline frame of the website 114 and that may be used to authenticate the website 114. In an embodiment, the virtual machine service provider 102 may provision a virtual machine instance through which the virtual hologram 116 may be generated and provided to the user 106 through the inline frame. The virtual machine instance may encode the virtual hologram 116 using one or more WebRTC protocols or through a VNC protocol into a series of pixels. The virtual machine instance may transmit a binary data stream that includes these pixels to the computing device 108 associated with the user 106, which may decode the binary data stream to compile the set of pixels into the graphical facsimile of the virtual hologram 116 through the inline frame on the website 114. Since the virtual hologram 116 is graphically represented using a set of pixels, inspection of the virtual hologram 116 associated with the particular website 114 is prevented. For instance, because the graphical facsimile of the virtual hologram 116 is generated through decoding of binary data streams from the virtual machine instance, a DOM inspector may be unable to process these binary data streams to inspect the virtual hologram 116 associated with the particular website 114. This may prevent users from being able to detect, from the DOM, any vulnerabilities or other features that may be exploited in order to dynamically recreate the virtual hologram 116 and spoof authentication of different websites.

As noted above, the virtual hologram 116 may encode an OTP or other time-based code that may be used to authenticate the virtual hologram 116 and the website 114. Accordingly, the OTP or other time-based code may be dynamically updated according to a pre-defined time interval or timestep. For instance, at each time interval or timestep, the virtual machine service provider 102 may use the virtual hologram seed and the initial time for the present time interval or timestep as input to the aforementioned hash function or other cryptographic algorithm to generate a new OTP or other time-based code. Using the new OTP or other time-based code, as well as the one or more characteristics or parameters associated with the website 114, the virtual machine service provider 102 may generate a new virtual hologram 116 that encodes the OTP/time-based code and the characteristics/parameters associated with the website 114. The virtual machine service provider 102 may dynamically update the data stream or the inline frame of the website 114 (according to how the website 114 is being presented through the browser application 112) to present the new virtual hologram 116. Thus, the virtual hologram 116 may be dynamically updated at each time interval or timestep.

In an embodiment, the virtual machine service provider 102 can provide, prior to the virtual hologram 116, a button or other user interface (UI) element on the website 114 that may be selected by the user 106 to request presentation of the virtual hologram 116. For instance, when the user 106 accesses the website 114, the virtual machine service provider 102 may initially present a button or other UI element in place of the virtual hologram 116. The button or other UI element may encode executable instructions that, when executed by a computing device 108, causes the computing device 108 to transmit a request to the virtual machine service provider 102 to present a virtual hologram 116 that may be used to verify the authenticity of the website 114. The executable instructions may include an indication of an API associated with the virtual machine service provider 102 through which the request for generation and presentation of a virtual hologram 116 may be transmitted to the virtual machine service provider 102.

The request to the virtual machine service provider 102 may include one or more elements associated with the website 114 that may be used by the virtual machine service provider 102 to authenticate the website 114. For instance, the request may include the IP address of the website 114, the URI used to access the website 114, and the like. In response to the request, the virtual machine service provider 102 may determine the website 114 is an authentic and legitimate website. For example, to make this determination, the virtual machine service provider 102 may process the provided URI and any other characteristics or parameters associated with the website 114 through a trained machine learning algorithm, as described above. The output of the trained machine learning algorithm may include an indication of whether the website 114 includes any suspicious elements that can be indicative of spoofing or other imitation of a legitimate website. In some instances, the output of the trained machine learning algorithm may indicate whether the website contains any suspicious elements and, thus, should not be authenticated (e.g., the website 114 is known to include malware, the website 114 includes interaction elements that may lead to the installation of malware, the website is tied to a suspicious entity, the website 114 is a phishing site, etc.).

If the virtual machine service provider 102 determines that the website 114 cannot be authenticated and/or is not a legitimate website 114, the virtual machine service provider 102 may deny the request to provide a virtual hologram 116 that may be used by the user 106 to verify the authenticity of the website 114. Accordingly, the website 114 may be presented devoid of a virtual hologram 116. This may serve as an indication to the user 106 that the website 114 is not authentic or legitimate. In some instances, if the virtual machine service provider 102 determines that the website 114 cannot be authenticated and/or is not a legitimate website 114, the virtual machine service provider 102 may automatically update the button or other UI element to indicate that the website 114 could not be authenticated by the virtual machine service provider 102. For instance, the virtual machine service provider 102 may replace the button or other UI element with a new UI element that includes an indication of the illegitimacy of the website 114 (e.g., a warning symbol, text indicating that the website 114 is not authentic, an auditory warning, etc.). Thus, in instances whereby the user 106 is required to request presentation of a virtual hologram 116, the virtual hologram 116 may not be generated and presented unless the website 114 is successfully authenticated by the virtual machine service provider 102.

In an embodiment, access to the website 114 may be controlled through one or more access control policies, whereby only authorized users may access the website 114. These access control policies may be maintained by the virtual machine service provider 102 such that when a user attempts to interact with the website 114, the virtual machine service provider 102 may determine, based on these access control policies, whether the user is authorized to access the website 114 or otherwise perform certain operations on the website 114. For example, an access control policy may allow an authorized user to solely have read access to the website 114, whereby the authorized user may be authorized to solely view elements of the website 114 through their browser application 112 without having permission to manipulate the website 114 (e.g., input text into any input fields on the website 114, select interaction elements of the website 114, etc.). As another example, an access control policy may allow an authorized user to perform both read and write operations within the website 114 (e.g., select interaction elements of the website 114, input text into the input fields on the website 114, etc.). In some instances, a granular access control policy may be generated through which the level of access to particular subsites of the website 114 and/or elements on the website 114 may be defined.

In an embodiment, when the user 106 first accesses the website 114, access to the various elements of the website 114 (e.g., any interaction elements, etc.) may be restricted until the user 106 scans the virtual hologram 116 and is successfully authenticated by the virtual machine service provider 102. When the user 106, using their mobile computing device 110 or other authentication device, scans the virtual hologram 116 presented on the website 114, the user 106 may provide credential information that may be used to authenticate the user 106 and identify any applicable access control policies for the website 114. The credential information may include, but is not limited to, biometric information, username and password, location information (e.g., IP geolocation data, Global Positioning System (GPS) data, etc.), IP or other network address, and the like.

As noted above, an application installed on the user's mobile device 110 or other authentication device may transmit the extracted characteristics/parameters associated with the website 114 and the OTP or other time-based code to the virtual machine service provider 102 through one or more APIs associated with the virtual machine service provider 102. In an embodiment, in addition to the extracted characteristics/parameters and the OTP, the application may transmit the user's credential information for authentication of the user 106. For instance, when the user 106 uses their mobile device 110 or other authentication device to scan the virtual hologram 116, the application installed on the user's mobile device 110 may automatically prompt the user 106 to provide their credential information for authentication of the user 106. As another illustrative example, the virtual hologram 116 may encode executable instructions that, when executed by the mobile device 110 or other authentication device, may cause the mobile device 110 or other authentication device to prompt the user 106 for credential information that may be used to authenticate the user 106. For example, the mobile device 110 or other authentication device may prompt the user 106 to perform a biometric scan (e.g., facial scan, retinal scan, fingerprint scan, etc.), which the mobile device 110 or other authentication device may use to locally authenticate the user 106. As another illustrative example, the mobile device 110 or other authentication device may prompt the user 106 to provide credential information (e.g., username and password, etc.) associated with an account corresponding to the provider of the operating system implemented on the mobile device 110 or other authentication device. The provider of the operating system may authenticate the provided credential information and accordingly provide an indication that the user 106 has been authenticated by this provider. The authentication determination performed through the mobile device 110 or other authentication device may be provided with the extracted characteristics/parameters and the OTP from the virtual hologram 116 to the virtual machine service provider 102.

In response to the one or more API calls from the application, the virtual machine service provider 102 may evaluate the provided credential information to determine whether the credential information is associated with an authorized user. For instance, if the user 106 has been authenticated through the application installed on their mobile computing device 110 or other authentication device (e.g., an application provided by the virtual machine service provider 102, an application provided by a website owner, an application provided by a third-party entity that maintains a trust relationship with the virtual machine service provider 102 and/or the website owner, etc.), the application may provide in the one or more API calls an indication that the user 106 has been successfully authenticated, as well as any other credential information that may be used to authenticate the application (e.g., cryptographic hashes, shared secrets, OTPs, etc.). If the application is authenticated, the virtual machine service provider 102 may trust the user authentication determination provided by the application. In some instances, the credential information associated with the application may be used to determine the provider of the application. This may allow the virtual machine service provider 102, through a separate communications session or other authentication process, communicate with the provider of the application to verify that the one or more API calls were submitted from an authentic application.

If the one or more API calls from the application are validated by the virtual machine service provider 102, and upon a determination that the presented virtual hologram 116 is authentic, the virtual machine service provider 102 may identify any access control policies that may be applicable for the present access to the website 114. For instance, using the provided credential information associated with the user 106, the virtual machine service provider 102 may determine whether the provided credential information is associated with an existing user profile. The user 106 may be associated with the virtual machine service provider 102 through having established an account with the virtual machine service provider 102 or otherwise being associated with an account maintained by the virtual machine service provider 102 (e.g., a delegated user, etc.). If the provided credential information is associated with a third-party entity (e.g., the website owner, the provider of the application used to submit the one or more API calls, an authentication service, etc.), the virtual machine service provider 102 may establish a secure communications session with the third-party entity to authenticate the provided credential information and obtain any available information associated with the user 106.

If the user 106 is successfully authenticated, the virtual machine service provider 102 may determine whether there are any access control policies that are applicable to the user's access of the website 114. For instance, the website owner and/or the virtual machine service provider 102 can define one or more access control policies corresponding to levels of access to different elements associated with the website 114 (e.g., subsites, interactable elements, read/write abilities, etc.). For instance, via an access control policy, safe hours and safe locations may be designated for use of the website 114 by an authorized user. As an illustrative example, an access control policy may be defined whereby the user 106 and/or other users may be authorized to access the website 114 during the website owner's business hours. If the user 106 or other user subject to this access control policy attempts to access the website 114 outside of this time period, the virtual machine service provider 102 may automatically restrict the authorized user's or other user's ability to access any elements of the website 114 (e.g., the website 114 may be presented in read-only mode, portions of the website 114 may be obscured or obfuscated, etc.). As another illustrative example, an access control policy may be defined whereby the user 106 and/or other users may access the different elements associated with website 114 from specific locations (e.g., a physical address, a computing device having a particular Internet Protocol (IP) address, etc.). When the user 106 and/or other users attempt to utilize the different elements associated with the website 114 from a location outside of the permissible locations defined in the access control policy (as determined by the virtual machine service provider 102, such as through GPS coordinates from the computing device 108 and/or mobile computing device 110, IP geolocation, etc.), the virtual machine service provider 102 may automatically restrict the authorized user's or other user's attempt to access these different elements associated with the website 114.

If the user 106 is authorized to access these different elements associated with the website 114, the virtual machine service provider 102 may allow user access to these different elements. For instance, if interactions with these different elements were restricted for unauthorized entities, the virtual machine service provider 102 may lift these restrictions for the user 106 once the user 106 has been authenticated and is deemed to be authorized to access these elements according to the applicable access control policy. As another illustrative example, when the user 106 initially accesses the website 114, certain portions or elements of the website 114 may be obscured or otherwise not available to the user 106. If the virtual machine service provider 102 determines that the user 106 is authorized to access these portions or elements of the website 114 (e.g., the user 106 is successfully authenticated and is authorized to access these portions or elements through an applicable access control policy), the virtual machine service provider 102 may automatically make these portions or elements of the website 114 visible or otherwise accessible to the user 106.

In an embodiment, the virtual machine service provider 102 can determine the level of access to the website 114 according to the intent of the user 106, as communicated through the one or more API calls to the virtual machine service provider 102 from the application installed on the user's mobile computing device 110 or other authentication device. An intent may (for example) be a topic, sentiment, complexity, and/or level of urgency. A topic can include, but is not limited to, a subject, a product, a service, a technical issue, a use question, a complaint, a refund request or a purchase request, etc. The intent of the user 106 may be automatically determined based on the application used to submit the one or more API calls to the virtual machine service provider 102 for authentication of the virtual hologram 116. For instance, in addition to providing the extracted characteristics/parameters and the OTP associated with the virtual hologram 116, the application may provide metadata or other information that may be used to uniquely identify the application. For example, if the application used to scan the virtual hologram 116 is associated with the owner of the website 114, and the user 106 has been authenticated by the owner of the website 114 through the application, the virtual machine service provider 102 may determine that the user 106 may be trying to access their account through the website 114. Accordingly, the virtual machine service provider 102 may automatically allow for the user's credentials associated with the website 114 to be used to access the user's account, such as through single sign-on (SSO) authentication, Security Assertion Markup Language (SAML) authentication, or any other authentication method. As another illustrative example, if the user 106 scans the virtual hologram 116 using a payment instrument application associated with an entity other than the website owner, the virtual machine service provider 102 may determine that the user 106 may be attempting to complete a transaction with the website owner through the website 114. Accordingly, if the virtual hologram 116 (and the website 114) is authenticated, the virtual machine service provider 102 may allow the application to supply any payment information for the transaction through the website 114 without additional user input.

In an embodiment, when the user 106 uses their mobile device 110 or other authentication device to scan the virtual hologram 116 presented on the website 114, the application installed on the user's mobile computing device 110 or other authentication device may transmit, through one or more APIs exposed by the virtual machine service provider 102, a request to obtain a separate virtual hologram that may be presented through a GUI or other interface associated with the application and that the user 106 may use to authenticate the application. For instance, in response to an API call from the application to authenticate the website 114, the virtual machine service provider 102 may use the OTP and other extracted information from the virtual hologram 116 to determine whether the virtual hologram 116 is valid, as described above. If the virtual machine service provider 102 determines that the virtual hologram 116 is valid (i.e., the website 114 is authentic), the virtual machine service provider 102 may query the virtual hologram seed datastore to identify the virtual hologram seed associated with the application. For instance, for each individual installation of the application on to a computing device, the virtual machine service provider 102 may dynamically generate a new virtual hologram seed that may be used to generate virtual holograms that are unique to the particular instance of the application. Thus, using the identified virtual hologram seed and a timestamp corresponding to the time at which the API call was made by the application, the virtual machine service provider 102 may dynamically generate a virtual hologram corresponding to the application installed on the user's mobile device 110 or other authentication device. This may allow the user 106 to determine that both the website 114 and the application executing on their mobile device 110 or other authentication device is authentic. Further, the additional virtual hologram presented through the application on the mobile device 110 or other authentication device may serve as another authentication layer for the website 114, as the additional virtual hologram is generated by the virtual machine service provider 102 upon a validation of the original virtual hologram 116 presented on the website 114.

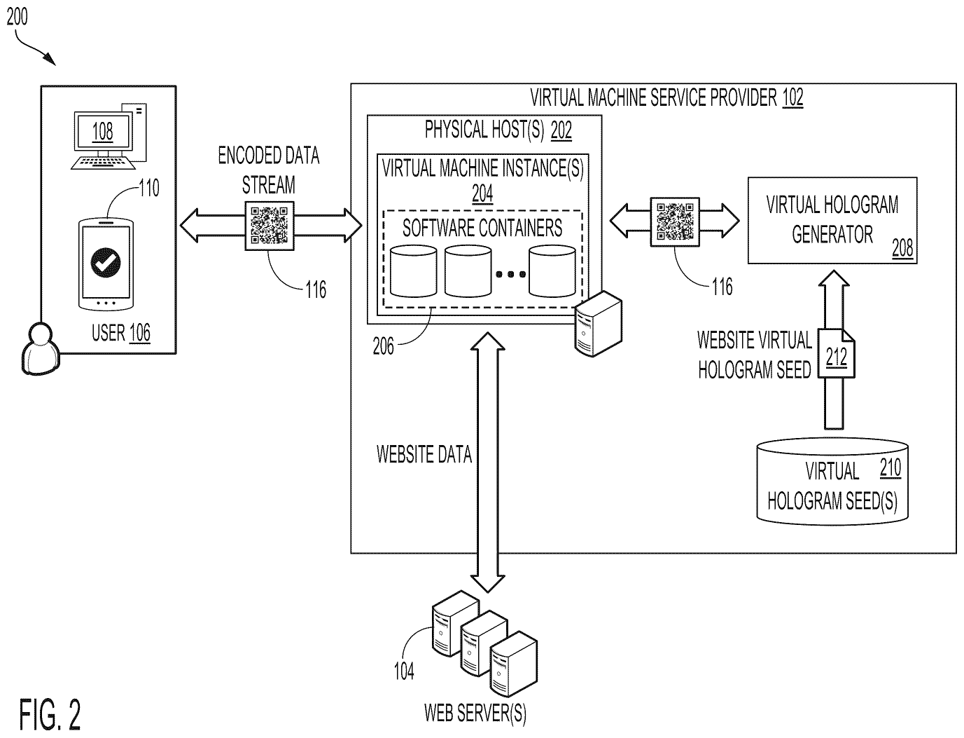

FIG. 2 shows an illustrative example of an environment 200 in which a virtual machine service provider 102 automatically encodes the web DOM associated with a website and a virtual hologram 116 to prevent exposure of the web DOM while providing a representation and method for authentication of the website to users in accordance with at least one embodiment. In the environment 200, an administrator of a particular website may access the virtual machine service provider 102 to configure automatic encoding of the particular website for presentation to users (e.g., user 106) when these users submit requests to access the particular website. For instance, the virtual machine service provider 102, in response to a request from the administrator of the website to automatically encode the particular website for presentation to users, may provide the administrator with various configuration options for a virtual machine instance through which a virtual environment may be implemented for encoding of the particular website into a data stream that may be transmitted to users requesting access to the website. For instance, the virtual machine service provider 102 may determine the available capacity for each of the physical hosts 202 maintained by the virtual machine service provider 102. Further, the virtual machine service provider 102 may query a virtual machine image repository to identify the available virtual machine images that may be used to instantiate the virtual environment on to a physical host 202. Based on this information, the virtual machine service provider 102 may determine which virtual machine images may be used to instantiate a virtual environment on to a physical host having the available capacity to support the virtual environment. The virtual machine service provider 102 may present, to the administrator, the available virtual machine images that may be instantiated onto available capacity of the physical hosts 202 for a virtual environment through which the website may be encoded.

In some instances, the administrator of the website may provide, in its request to instantiate a virtual environment onto a physical host 202, a set of configuration requirements for the virtual environment. For instance, the administrator may specify that the virtual environment is to be supported by a virtual machine instance 204 having a minimum amount of random-access memory (RAM), a minimum number of vCPUs, minimum storage capacity, minimum amount of available bandwidth, and the like. Further, the administrator may specify which browser application is to be implemented within the virtual environment for rendering of the website prior to encoding into a data stream for presentation to the user 106. For instance, the administrator may specify that the virtual environment is to implement a Google Chrome™ browser application as opposed to Microsoft Edge®, Mozilla Firefox®, or any other available browser application. Alternatively, the administrator may specify that it is agnostic as to which browser application is implemented within the virtual environment so long as the minimum configuration requirements are satisfied.

If the administrator provides a set of configuration requirements for the virtual environment, the virtual machine service provider 102 may determine whether these requirements may be satisfied using the available capacity of the physical hosts 202 and a virtual machine image that, when instantiated, provides the required functionality requested by the administrator. For instance, the virtual machine service provider 102 may determine, based on an evaluation of the physical hosts 202, the available capacity of the physical hosts 202 for instantiation of a virtual machine image. If the available capacity does not satisfy the administrator's configuration requirements, the virtual machine service provider 102 may reject the request. Alternatively, the virtual machine service provider 102 may queue the administrator's request until a physical host 202 becomes available that has sufficient available capacity to satisfy the administrator's configuration requirements.

In some instances, the virtual machine service provider 102 may further identify any available virtual machine images that may be used to instantiate the virtual environment on to a physical host 202 according to the administrator's configuration requirements. For instance, a virtual machine image may have a corresponding set of configuration requirements for instantiation, whereby these configuration requirements may represent an average level of performance for a virtual machine instance 204 instantiated using the virtual machine image. Thus, the virtual machine service provider 102 may identify any virtual machine images that satisfy the administrator's configuration requirements. The virtual machine service provider 102 may present these virtual machine images to the administrator to allow the administrator to select a virtual machine image that may be instantiated onto a physical host 202 to implement the virtual environment.

In an embodiment, the virtual machine service provider 102 instantiates a virtual machine instance 204 to implement the virtual environment through which the website may be encoded into a data stream for presentation to users, such as user 106. The virtual machine instance 204 may include an operating system, a browser application, and a variety of other applications that may be executed to support the browser application and any other functionality required for the implementation of the virtual environment. The virtual machine service provider 102 may restrict access to the virtual machine instance 204 instantiated for the virtual environment such that users may only be able to access the virtual environment and the data stream.

In an embodiment, the virtual machine instance 204 is instantiated as a container instance that is configured to operate myriad software containers 206 according to the parameters of the virtual machine image. The virtual machine instance 204 may include a set of software containers 206 that may execute in isolation from each other (e.g., a software container may have an isolated view of a file system, etc.). A software container 206 may operate under the virtual machine instance 204 and can include one or more applications or programs, data, system libraries, and the like. Further, when a software container 206 is executed, the one or more applications or programs executed therein may be isolated from other applications or programs being executed within the virtual machine instance 204. For instance, the myriad software containers 206 implemented in the virtual machine instance 204 may each operate on an operating system (using the computing resources allocated to the software container 206) in isolation from one another. For instance, an encoder implemented to encode the web DOM associated with a particular website using one or more WebRTC protocols or through a VNC protocol into a series of pixels may be executed on a software container isolated from other processes operating within the virtual machine instance 204. The virtual machine instance 204 may implement a software container for the operating system, a software container that encodes the web DOM for one or more websites into a series of pixels, a software container for personal settings, and the like.

The software container used to implement the encoder may be configured to only have limited access to resources available via other software containers of the virtual machine instance 204. Thus, the software container may be executed to have access to only certain resources from the computing resources allocated for the virtual machine instance 204. Due to this isolation, a user of the virtual environment may only be able to access the data stream provided by the encoder. This may prevent users from accessing the operating system, file systems, and other resources associated with the virtual machine instance, providing an additional layer of security for the virtual environment.

In an embodiment, the virtual machine instance 204, through the one or more software containers 206, encodes the web DOM associated with the particular website using one or more WebRTC protocols or through a VNC protocol into a series of pixels. The virtual machine instance 204 may transmit a binary data stream that includes these pixels to a client (e.g., the computing device 108 associated with a requesting user 106, etc.), which may decode the binary data stream to compile the set of pixels into the graphical facsimile of the particular website on the client, such as through a browser application. Since the particular website is graphically represented using a set of pixels rather than through the web DOM associated with the particular website, inspection of the web DOM associated with the particular website is prevented. For instance, because the graphical facsimile of the particular website is generated through decoding of binary data streams from the virtual machine instance 204, a DOM inspector may be unable to process these binary data streams to inspect the web DOM associated with the particular website.

In an embodiment, the virtual machine service provider 102 can define a custom data structure that may be used to encode one or more portions of the web DOM associated with the particular website. For example, the virtual machine service provider 102 may define a custom encoder that may be used by the virtual machine instance 204 (such as through one or more software containers 206) to encode one or more portions of the web DOM. In some instances, the custom encoder may be implemented to encode text and a binary image associated with the particular website into a data format that may be compressed and encrypted for delivery to a client. The client (which is provided with the cryptographic key(s) for decrypting the data stream from the virtual machine instance 204) may decrypt and decompress the data stream comprising the encoded text and binary image. Further, the client may decode the text and binary image to render the graphical facsimile of the particular website according to the preferences defined by the virtual machine service provider 102 through definition of the custom encoder. In some instances, the decoder provided to the client for decoding the encoded text and binary image may be defined through custom JavaScript libraries and/or other libraries defined using appropriate programming languages.

In an embodiment, the virtual machine service provider 102 can provide the administrator of the website with one or more options corresponding to different protocols that may be used to encode one or more portions of the web DOM associated with the particular website. For example, the administrator or other entity responsible for management of the particular website may be provided, through an interface, with a set of protocols made available by the virtual machine service provider 102 for encoding the particular website according to any of the aforementioned methods. For instance, through this interface, the virtual machine service provider 102 may present the administrator with options to utilize a WebRTC protocol, a VNC protocol, any custom protocols or encoders defined by the virtual machine service provider 102, and the like for encoding of the particular website. Further, through the interface, the virtual machine service provider 102 may provide the administrator or other entity with various options with regard to the portions of the website that are to be encoded according to a selected protocol. For example, the virtual machine service provider 102, through the virtual machine instance 204, may render the website according to the web DOM and corresponding scripts and assets associated with the website through a virtual environment. Through the virtual environment, the different portions of the website may be indicated such that the administrator or other entity may readily discern which portions of the website correspond to the different portions of the web DOM. Further, through the virtual environment, the administrator or other entity may select which portions of the website are to be encoded. Based on this selection, the virtual machine instance 204 may automatically identify the corresponding portions of the web DOM, as well as the corresponding assets and scripts, that are to be encoded according to the selected encoding protocol.

In an embodiment, when the administrator configures a virtual machine instance 204 to serve as a proxy of the particular website in order to encode the web DOM associated with the particular website into a graphical facsimile of the particular website for users, the virtual machine service provider 102 updates one or more DNS servers to map the URI associated with the particular website with an IP address corresponding to the virtual machine instance 204. For example, while the data (e.g., web DOM, web assets, etc.) associated with a particular website may reside within one or more web servers 104 maintained by the administrator of the particular website, the URI corresponding to the particular website may be mapped to an IP address associated with the virtual machine instance 204 implemented by the virtual machine service provider 102 as opposed to an IP address associated with the one or more web servers 104. Further, the virtual machine instance 204 may be configured to automatically access the one or more web servers 104 in response to a request to access the website to obtain the web DOM and other assets associated with the website for encoding into the graphical facsimile of the website. Thus, if a user 106 enters, through a browser application implemented on their computing device 108, the URI corresponding to the particular website, the user 106 may be automatically directed to the virtual machine instance 204 implemented by the virtual machine service provider 102 as opposed to the one or more web servers 104 that maintain the web DOM and other assets associated with the particular website.

In an embodiment, when the administrator of the particular website configures the virtual machine instance 204 to serve as a proxy of the website, the virtual machine service provider 102 automatically generates or otherwise provisions a virtual hologram seed 212 that may be used to dynamically generate virtual holograms 116 that may be used by different users to authenticate the website. As noted above, the virtual hologram seed 212 may be a static value or cryptographic key that, along with a timestamp corresponding to a current time, may be used as input to a hash function or other cryptographic algorithm to generate unique OTPs for the website.

In an embodiment, when a user 106, through a browser application implemented on their computing device 108, submits a request to access the website, the virtual machine instance 204 may transmit, in real-time or near real-time, a request to a virtual hologram generator 208 to dynamically generate a virtual hologram 116 that may be presented to the user 106 and that may be used by the user 106 to authenticate the website. The virtual hologram generator 208 may be implemented using a computer system or as an application or other executable code implemented on a computer system of the virtual machine service provider 102. The request to generate the virtual hologram 116 may include one or more characteristics or parameters associated with the website (e.g., the name of the internet-based service associated with the website, the URI corresponding to the website, country of registration, website domain age, etc.). In response to the request from the virtual machine instance 204, the virtual hologram generator 208 may use the provided characteristics or parameters associated with the website to query a virtual hologram seed datastore 210 to obtain the virtual hologram seed 212 corresponding to the website.

The virtual hologram generator 208 may further determine the current time interval or timestep that, in conjunction with the virtual hologram seed 212, may be used to dynamically generate an OTP or other time-based code that may be encoded in the virtual hologram 116. As noted above, at each time interval or timestep, the virtual hologram generator 208 may use the virtual hologram seed 212 and the initial time for the present time interval or timestep as input to a hash function or other cryptographic algorithm to generate a new OTP or other time-based code for the virtual hologram 116. Using the new OTP or other time-based code, as well as the one or more characteristics or parameters associated with the website, the virtual hologram generator 208 may generate a virtual hologram 116 that encodes the OTP/time-based code and the characteristics/parameters associated with the website. As noted above, the virtual hologram 116 may be implemented as a QR code or any form of one- or two-dimensional code that can be used to encode information and/or executable instructions. The virtual hologram 116 may, in some instances, include an image corresponding to the virtual machine service provider 102 and/or the internet-based service associated with the website being presented.

The virtual hologram generator 208 may provide the virtual hologram 116 to the virtual machine instance 204 for incorporation of the virtual hologram 116 into the data stream. For instance, if the website includes an inline frame through which a virtual hologram 116 may be presented, the virtual machine instance 204 may configure the data stream such that a graphical facsimile of the virtual hologram 116 is presented to the user 106 within this inline frame in the graphical facsimile of the particular website. In some instances, the virtual machine instance 204 may automatically incorporate the virtual hologram 116 into the data stream at a location pre-defined by the virtual machine service provider 102 and independent of any website elements defined through the web DOM.

As noted above, the user 106, using a mobile computing device 110, may scan the graphical representation of the virtual hologram 116 to determine whether the graphically represented website has been vetted by the virtual machine service provider 102 and is authentic. For instance, when the user 106 uses their mobile computing device 110 to scan the virtual hologram 116, the mobile computing device 110 may use the URI encoded in the virtual hologram 116 to transmit a request to the virtual machine service provider 102 to determine whether the website is authentic. This request may include (as extracted from the virtual hologram 116) the one or more characteristics or parameters associated with the graphically represented website and the OTP or other time-based code that may be used to authenticate the website. In some instances, the user 106 may execute an application provided by the virtual machine service provider 102 and installed on their mobile computing device 110 to automatically engage one or more integrated or peripheral devices (e.g., a camera, a scanner, etc.) associated with the mobile computing device 110 to scan the presented virtual hologram 116. In some instances, the virtual hologram 116 may encode executable instructions that, when scanned by the mobile computing device 110, may cause the mobile computing device 110 to execute the application. In an embodiment, the application transmits the extracted characteristics/parameters associated with the website and the OTP or other time-based code to the virtual machine service provider 102 through one or more APIs associated with the virtual machine service provider 102.

In response to the request from the user 106, the virtual machine service provider 102, through the virtual hologram generator 208, may determine whether the provided OTP or other time-based code is valid. The virtual hologram generator 208 may query the virtual hologram seed datastore 210 using the extracted characteristics/parameters associated with the website to determine whether a virtual hologram seed 212 is available for the website. If the virtual hologram generator 208 is unable to identify a virtual hologram seed 212 corresponding to the website, the virtual hologram generator 208 may transmit a response to the request from the user 106 indicating that the website could not be authenticated.

If the virtual hologram generator 208 identifies a virtual hologram seed 212 associated with the particular website, the virtual hologram generator 208 may use the virtual hologram seed 212 and the initial time for the time interval or timestep corresponding to the time at which the website was accessed to generate the expected OTP or other time-based code. This expected OTP or other time-based code may serve as the ground truth for authentication of the website such that if a different OTP or other time-based code is provided for authentication of the website, the virtual hologram generator 208 may automatically determine that the different OTP or other time-based code is invalid. Thus, if the request from the user 106 includes an OTP or other time-based code that differs from the expected OTP or other time-based code generated by the virtual hologram generator 208, the virtual hologram generator 208 may determine that the virtual hologram 116 being presented to the user 106 in association with the website is not valid. Accordingly, the virtual hologram generator 208 may transmit a notification to the user 106 to indicate that the website could not be authenticated.

If the virtual hologram generator 208 determines that the provided OTP or other time-based code matches the expected OTP or other time-based code generated by the virtual hologram generator 208, the virtual hologram generator 208 may determine that the website is authentic. Accordingly, the virtual hologram generator 208 may transmit a notification to the user 106 to indicate that the website has been vetted and that it is authentic. For instance, if the request to authenticate the website was submitted through a website provided by the virtual machine service provider 102, the virtual hologram generator 208 may update an interface associated with this website provided by the virtual machine service provider 102 to indicate that the third-party website (e.g., the website encoded into a data stream transmitted to the user 106) is authentic and legitimate. As another illustrative example, if the request to authenticate the website was submitted by an application installed on the mobile computing device 110 through one or more APIs, the virtual hologram generator 208, through these one or more APIs, may transmit a notification to the application to indicate that the website has been authenticated and is legitimate. Accordingly, the application may update an interface (e.g., GUI) implemented by the application to present an indication that the website has been authenticated by the virtual hologram generator 208 and is authentic.

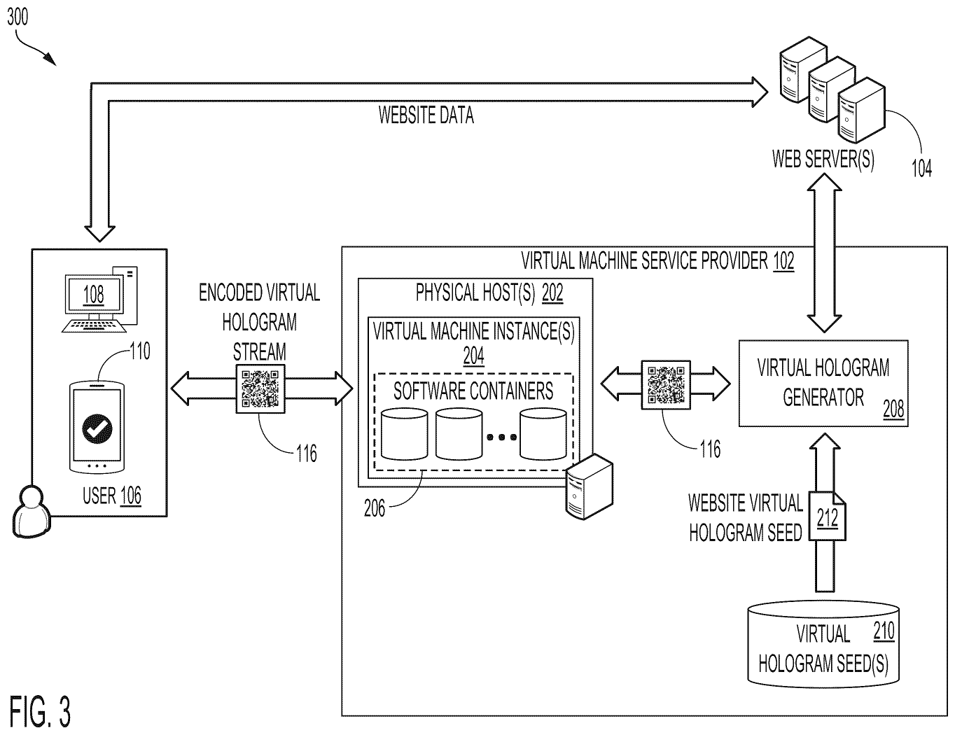

FIG. 3 shows an illustrative example of an environment 300 in which a virtual machine service provider 102 dynamically generates and embeds onto a website a virtual hologram 116 usable to allow for authentication of the website in accordance with at least one embodiment. The virtual machine service provider 102 in the environment 300 may be similar to the virtual machine service provider described above in connection with FIG. 2. For instance, the virtual machine service provider 102 may implement a plurality of physical hosts 202 through which virtual machine instances 204 may be instantiated to provide encoded data streams to users. Further, the virtual machine instances 204 may be instantiated as container instances that are configured to operate myriad software containers 206 according to the parameters of the different virtual machine images used to instantiate the virtual machine instances 204.

As noted above, the virtual hologram 116 can be presented on a website through an inline frame that, when executed, is configured to retrieve the virtual hologram 116 from the virtual machine service provider 102. In the environment 300, when the user 106, through the browser application installed on their computing device 108, submits a URI corresponding to the website, the web servers 104 associated with the website may provide the web DOM and other web assets that may be used to render the website through the browser application. The website may include an inline frame or other executable code that may be executed to obtain and present a virtual hologram 116 that is usable for authentication of the website. The inline frame or other executable code may include a URI corresponding to the virtual hologram generator 208 of the virtual machine service provider 102, which the browser application implemented on the computing device 108 may use to access the virtual hologram generator 208 and to submit a request to the virtual hologram generator 208 to obtain a virtual hologram 116 that may be presented through the inline frame and usable to authenticate the website. In some instances, the inline frame or other executable code, when executed, may cause the browser application to submit the request through one or more APIs exposed by the virtual machine service provider 102 and through which the browser application may submit a request to the virtual hologram generator 208 to obtain the virtual hologram 116. The request from the browser application may include the URI associated with the website as well as any other characteristics or parameters associated with the website that may be used to authenticate the website.

In response to the request from the browser application, the virtual hologram generator 208 may evaluate the URI associated with the website, as well as any other provided characteristics or parameters associated with the website, to determine whether the website is authentic. For instance, if the URI associated with the website and/or any other provided characteristics or parameters associated with the website are suspicious in nature (e.g., the website is known to include malware, the website includes interaction elements that may lead to the installation of malware, the website is tied to a suspicious entity, the website is a phishing site, etc.), the virtual hologram generator 208 may automatically reject the request. Accordingly, the website may be presented through the browser application without a virtual hologram 116, which may serve as an indication to the user 106 that the website could not be authenticated. In some instances, in place of the virtual hologram 116, the virtual hologram generator 208 may provide, through the inline frame, an indication that the website could not be authenticated.

As noted above, if the virtual hologram generator 208 determines that the website is not authentic, the virtual hologram generator 208 may determine whether there is a legitimate website that can be presented to the user 106. For example, the virtual hologram generator 208 may process the URI associated with the website against a repository of known URIs for legitimate websites to determine whether a legitimate website can be identified. Additionally, or alternatively, the virtual hologram generator 208 can process the provided characteristics or parameters associated with the website to identify any elements associated with a legitimate entity that are being spoofed or misappropriated for a nefarious purpose. Based on this identification of elements associated with a legitimate entity, the virtual hologram generator 208 may identify a legitimate website that the user 106 may be re-directed to via the browser application or a virtual machine instance through which the legitimate website may be rendered and presented to the user 106 through the browser application.

The virtual hologram generator 208, in an embodiment, implements a machine learning algorithm or artificial intelligence that is dynamically trained to identify the elements associated with a legitimate entity from the other provided characteristics or parameters associated with the website and/or to identify a legitimate website based on evaluation of the suspicious URI associated with the website. The machine learning algorithm or artificial intelligence may be trained using a dataset of web assets (including any corresponding characteristics or parameters) associated with a set of sample websites, URIs or other network addresses associated with the set of sample websites, known elements associated with legitimate entities, and known URIs corresponding to these legitimate entities. The machine learning algorithm or artificial intelligence may be updated, based on the URIs produced using the sample inputs supplied to the machine learning algorithm or artificial intelligence. Additionally, the machine learning algorithm or artificial intelligence may be updated by soliciting feedback from different users. For instance, if the virtual hologram generator 208 re-directs a user to a legitimate website that is wholly unrelated to the elements associated with a legitimate entity and presented on the website, the user may provide feedback to the virtual hologram generator 208 indicating that the website the user was re-directed to was not relevant or otherwise not useful to the user. The virtual hologram generator 208 may use this feedback to modify one or more coefficients of the machine learning algorithm or artificial intelligence to better identify a legitimate website associated with the elements associated with the legitimate entity being imitated. Similarly, a user may provide feedback regarding the ability of the machine learning algorithm or artificial intelligence to identify suspicious URIs. This feedback may be used to update the machine learning algorithm or artificial intelligence to better identify suspicious URIs and identify legitimate URIs corresponding to legitimate entities.

In some instances, if the virtual hologram generator 208 determines that the website cannot be authenticated, the virtual hologram generator 208 may re-direct the user 106 to a virtual environment implemented by the virtual machine service provider 102 through which the user 106 may access a legitimate website. For instance, the virtual hologram generator 208 may automatically instantiate a virtual machine instance 204 to implement the virtual environment through which the legitimate website may be encoded into a data stream for presentation to the user 106 through their browser application. This virtual machine instance 204 may be instantiated according to the process described above in connection with FIG. 2. For instance, through the newly provisioned virtual environment, the virtual machine instance 204 may encode the web DOM associated with the legitimate website and may transmit a data stream that includes the encoded website to the computing device 108 associated with the user 106, which may decode the data stream to generate the graphical facsimile of the legitimate website. Additionally, through this data stream, the virtual hologram generator 208 may encode the virtual hologram 116, which the user 106 may use to authenticate the website.

If the virtual hologram generator 208 determines, based on the provided URI and the parameters/characteristics associated with the website, that the website is authentic and legitimate, the virtual hologram generator 208 may query the virtual hologram seed datastore 210 to determine whether a virtual hologram seed 212 corresponding to the website is available. For instance, an administrator of the particular website may transmit a request to the virtual machine service provider 102 to dynamically generate and provide virtual holograms through the particular website for authentication of the website. In response to the request, the virtual hologram generator 208 may automatically generate or otherwise provision a virtual hologram seed 212 that may be used to dynamically generate virtual holograms 116 that may be used by different users to authenticate the website. If the virtual hologram seed datastore 210 does not maintain a virtual hologram seed 212 corresponding to the website, the virtual hologram generator 208 may automatically generate or otherwise provision the virtual hologram seed 212 for the website. This new virtual hologram seed 212 may be stored in the virtual hologram seed datastore 210 within an entry corresponding to the website. This entry may be keyed according to the URI and/or the characteristics/parameters associated with the website.

Using the virtual hologram seed 212 associated with the website, the virtual hologram generator 208 may dynamically generate a virtual hologram 116 that may be presented through the inline frame of the website and that may be used to authenticate the website. In some instances, to present the virtual hologram 116 through this inline frame or other element of the website, the virtual hologram generator 208 may dynamically provision a new virtual machine instance 204 through which the virtual hologram 116 may be provided to the user 106. The virtual machine instance 204 may encode the virtual hologram 116 from the virtual hologram generator 208 into a data stream that may be transmitted to the browser application implemented on the computing device 108. The computing device 108 may decode this data stream to generate a graphical facsimile of the virtual hologram 116 within the inline frame or other element of the website. Since the virtual hologram 116 is graphically represented using a set of pixels, inspection of the virtual hologram 116 associated with the website is prevented.

The user 106, using their mobile computing device 110, may scan the graphical representation of the virtual hologram 116 presented through the inline frame or other website element to determine whether the website is authentic. As noted above, when the user 106 uses their mobile computing device 110 to scan the virtual hologram 116, the mobile computing device 110 may use the URI encoded in the virtual hologram 116 to transmit a request to the virtual machine service provider 102 to determine whether the website is authentic. The request may include (as extracted from the virtual hologram 116) the one or more characteristics or parameters associated with the website and the OTP or other time-based code that may be used to authenticate the website. In some instances, the user 106 may execute an application provided by the virtual machine service provider 102 and installed on their mobile computing device 110 to automatically engage one or more integrated or peripheral devices to scan the presented virtual hologram 116. In some instances, the virtual hologram 116 may encode executable instructions that, when scanned by the mobile computing device 110, may cause the mobile computing device 110 to execute the application. In an embodiment, the application transmits the extracted characteristics/parameters associated with the website and the OTP or other time-based code to the virtual machine service provider 102 through one or more APIs associated with the virtual machine service provider 102.

In response to the request from the user 106, the virtual machine service provider 102, through the virtual hologram generator 208, may determine whether the provided OTP or other time-based code is valid. The virtual hologram generator 208 may query the virtual hologram seed datastore 210 using the extracted characteristics/parameters associated with the website to determine whether a virtual hologram seed 212 is available for the website. If the virtual hologram generator 208 is unable to identify a virtual hologram seed 212 corresponding to the website, the virtual hologram generator 208 may transmit a response to the request from the user 106 indicating that the website could not be authenticated. If the virtual hologram generator 208 identifies a virtual hologram seed 212 associated with the particular website, the virtual hologram generator 208 may use the virtual hologram seed 212 and the initial time for the time interval or timestep corresponding to the time at which the website was accessed to generate the expected OTP or other time-based code. If the OTP or other time-based code provided by the user 106 differs from the expected OTP or other time-based code generated by the virtual hologram generator 208, the virtual hologram generator 208 may determine that the virtual hologram 116 being presented to the user 106 is not valid. Accordingly, the virtual hologram generator 208 may transmit a notification to the user 106 to indicate that the website could not be authenticated. However, if the virtual hologram generator 208 determines that the provided OTP or other time-based code matches the expected OTP or other time-based code generated by the virtual hologram generator 208, the virtual hologram generator 208 may determine that the website is authentic. Accordingly, the virtual hologram generator 208 may transmit a notification to the user 106 to indicate that the website has been vetted and that it is authentic.

As noted above, the OTP or other time-based code (and, accordingly, the virtual hologram 116) may be dynamically updated according to a pre-defined time interval or timestep. For instance, at each time interval or timestep, the virtual hologram generator 208 may use the virtual hologram seed 212 and the initial time for the present time interval or timestep as input to the aforementioned hash function or other cryptographic algorithm to generate a new OTP or other time-based code. Using the new OTP or other time-based code, as well as the one or more characteristics or parameters associated with the website, the virtual hologram generator 208 may generate a new virtual hologram 116 that encodes the newly generated OTP/time-based code and the characteristics/parameters associated with the website. The virtual hologram generator 208, through the virtual machine instance 204 provisioned to provide the virtual hologram 116, may dynamically update the data stream or the inline frame of the website (according to how the website is being presented to the user 106) to present the updated virtual hologram 116. Thus, the virtual hologram 116 may be dynamically updated at each new time interval or timestep.

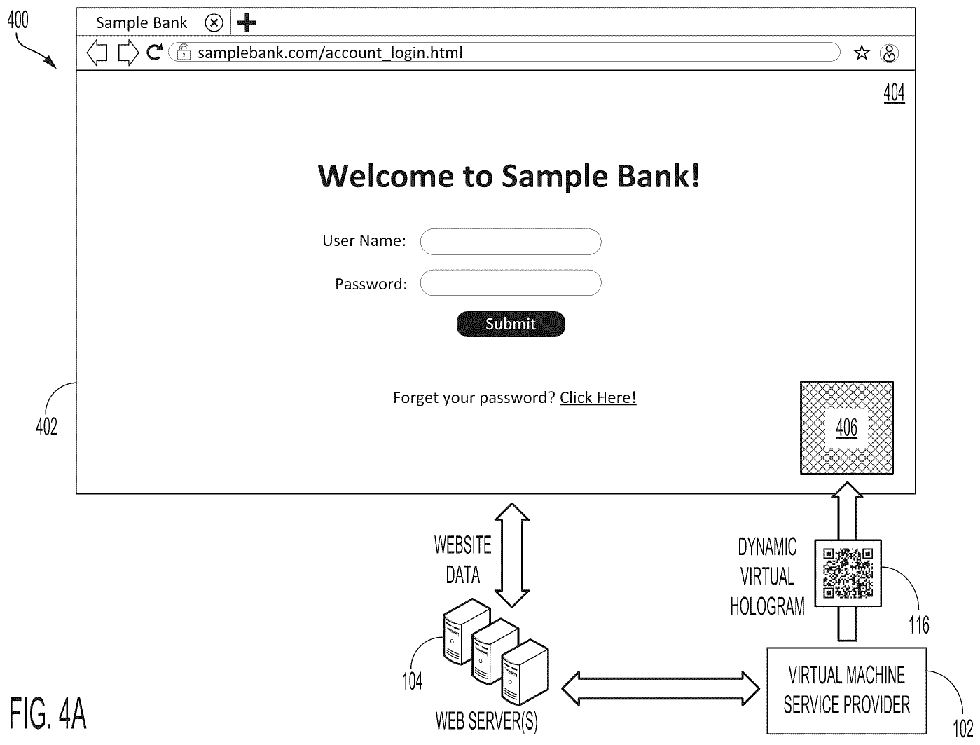

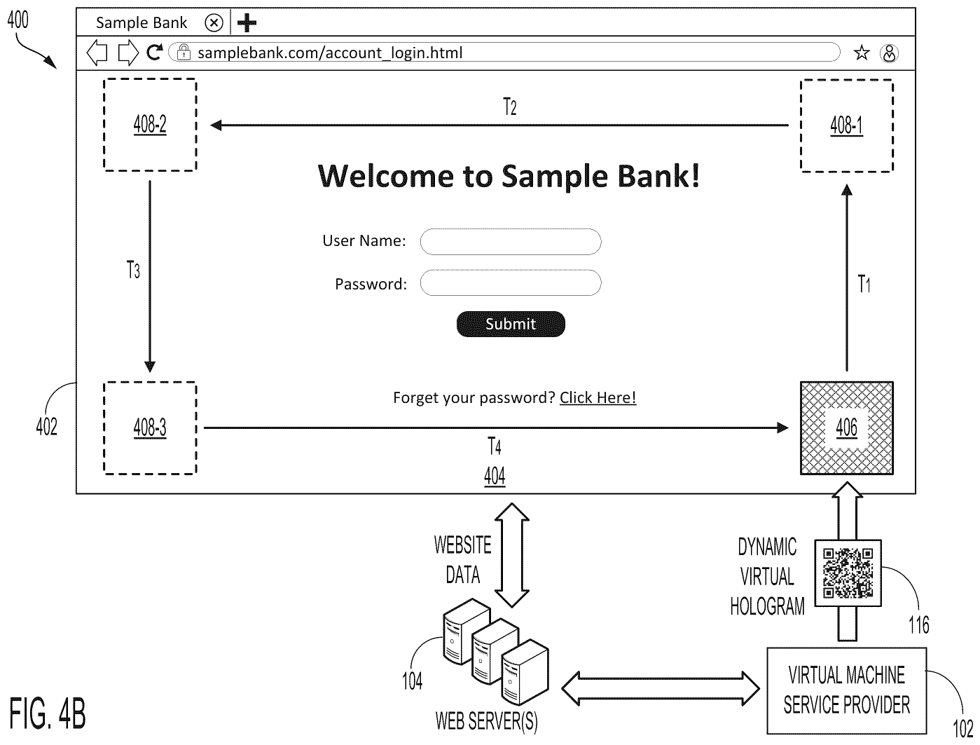

FIGS. 4A and 4B show an illustrative example of an environment 400 in which a virtual machine service provider 102 dynamically generates and embeds a virtual hologram 116 onto an inline frame 406 of a website 404 for use in authenticating the website 404 in accordance with at least one embodiment. In the environment 400 and as illustrated in FIG. 4A, a user, through a browser application 402 installed on their computing device, may enter the URI corresponding to a particular website 404. The website 404 may be implemented using a web DOM and corresponding scripts and assets associated with the website 404 that, when received by the browser application 402 from one or more web servers 104, may be used to render the website 404. As illustrated in FIG. 4A, the website 404 may include an inline frame 406 which may be reserved for the presentation of a virtual hologram 116 that may be used for authentication of the website 404 by a user of the browser application 402.

In an embodiment, the inline frame 406 includes a URI corresponding to the virtual machine service provider 102, which the browser application 402 may automatically utilize to access the virtual machine service provider 102 to request authentication of the website 404 and generation of a virtual hologram 116 that may be presented through the inline frame 406 to allow users to verify the authenticity of the website 404. In some instances, the inline frame 406 may include executable code that, when executed by the browser application 402, may cause the browser application 402 to transmit, through one or more APIs exposed by the virtual machine service provider 102, an API call to the virtual machine service provider 102 to request generation of a virtual hologram 116 that may be used by users of the browser application 402 to authenticate the website 404. As noted above, the request to the virtual machine service provider 102 to generate a virtual hologram 116 that may be presented through the inline frame 406 may include the URI associated with the website 404 as well as any other characteristics or parameters associated with the website 404 and that may be used by the virtual machine service provider 102 to authenticate the website 404 (e.g., the name of the internet-based service associated with the website 404, country of registration, website domain age, etc.).

In response to the request from the browser application 402, the virtual machine service provider 102 may evaluate, in real-time or near real-time, the URI corresponding to the website 404 and any provided characteristics or parameters associated with the website 404 to determine whether the website 404 can be authenticated. As noted above, the virtual machine service provider 102 may determine if the URI of the website 404 and/or any of the provided characteristics or parameters include one or more elements that may be indicative of a suspicious website (e.g., the website is known to include malware, the website includes interaction elements that may lead to the installation of malware, the website is tied to a suspicious entity, the website is a phishing site, etc.). In some instances, to make this determination, the virtual machine service provider 102 may process the provided URI and any other characteristics or parameters associated with the website 404 through a trained machine learning algorithm, as described above. The output of the trained machine learning algorithm may include an indication of whether the website 404 includes any suspicious elements that can be indicative of spoofing or other imitation of a legitimate website. In some instances, the output of the trained machine learning algorithm may indicate whether the website 404 contains any suspicious elements and, thus, should not be authenticated (e.g., the website is known to include malware, the website includes interaction elements that may lead to the installation of malware, the website is tied to a suspicious entity, the website is a phishing site, etc.).

If the virtual machine service provider 102 determines that the website 404 cannot be authenticated, the virtual machine service provider 102 may automatically reject the request from the browser application 402. In some instances, the virtual machine service provider 102 may transmit a notification to the browser application 402 to indicate that the website 404 could not be authenticated. Since this notification does not include a virtual hologram 116 that may be used by users to authenticate the website 404, the inline frame 406 may remain empty or otherwise devoid of any content. This may serve as an indication to the user that the website 404 could not be authenticated by the virtual machine service provider 102. In some instances, if the website 404 could not be authenticated by the virtual machine service provider 102, the virtual machine service provider 102 may provide content that may be presented through the inline frame 406 and that provides a graphical indication of the inability of the virtual machine service provider 102 to authenticate the website 404. For instance, through the inline frame 406, the virtual machine service provider 102 may present text, images, video, and/or other elements that may be easily processed by a user to determine that the website 404 could not be authenticated.

As noted above, in some instances, if the virtual machine service provider 102 determines that the website 404 could not be authenticated, the virtual machine service provider 102 may automatically determine whether there is a legitimate website that can be presented to the user through the browser application 402. For example, if through the evaluation of the website URI and corresponding characteristics or parameters the virtual machine service provider 102 identifies a URI of an alternative and legitimate website, the virtual machine service provider 102, through the browser application 402, may automatically re-direct the user to a virtual machine instance instantiated by the virtual machine service provider 102 and through which the user may access the legitimate website. The virtual machine instance may dynamically encode the legitimate website into a data stream that may be transmitted to the browser application 402. The browser application 402 may dynamically decode this data stream to generate a graphical facsimile of the legitimate website that may be presented to the user through the browser application 402, as described above.

If the virtual machine service provider 102 determines that the website 404 is authentic and legitimate, the virtual machine service provider 102 may determine whether a virtual hologram seed is available for the particular website 404. For instance, when an administrator of a website 404 establishes a relationship with the virtual machine service provider 102 (such as through the creation of an authentication account, etc.), the virtual machine service provider 102 may automatically generate a virtual hologram seed that may be uniquely associated with the website 404. The virtual hologram seed may be a static value or cryptographic key that, along with a timestamp corresponding to a current time interval or timestep, may be used as input to a hash function or other cryptographic algorithm to generate unique OTPs for the website 404. If the virtual machine service provider 102 has not previously provisioned a virtual hologram seed for the website 404, the virtual machine service provider 102 may dynamically generate a virtual hologram seed for the website 404.

The virtual machine service provider 102 may use the virtual hologram seed associated with the website 404 and the initial time corresponding to the present time interval or timestep (as determined based on the time at which the request was received) as input to the hash function or other cryptographic algorithm to generate an initial OTP or other time-based code for the virtual hologram 116. This initial OTP or other time-based code, as well as any required characteristics/parameters of the website 404 (e.g., website URI, the name of the internet-based service associated with the website 404, country of registration, website domain age, etc.), may be encoded by a virtual hologram generator of the virtual machine service provider 102 into a dynamic virtual hologram 116 that may be presented through the inline frame 406. In some instances, the dynamic virtual hologram 116 may further encode a URI associated with the virtual machine service provider 102 and that may be used to access a website implemented by the virtual machine service provider 102 for validating the virtual hologram 116 and, hence, the website 404. In some instances, the dynamic virtual hologram 116 may encode executable instructions that, when scanned and executed another computing device, may cause the other computing device to execute an application associated with the virtual machine service provider. This application may automatically transmit, through one or more APIs exposed by the virtual machine service provider 102, a request to validate the virtual hologram 116 provided through the inline frame 406.

As noted above, a user, using another computing device, may scan the virtual hologram 116 presented through the inline frame 406 to determine whether the website 404 is authentic. This may cause the other computing device (such as through a browser application or through an application provided by the virtual machine service provider 102) to transmit a request to the virtual machine service provider 102 to determine whether the virtual hologram 116 is valid. The request may include (as extracted from the virtual hologram 116) the one or more characteristics or parameters associated with the website 404 and the OTP or other time-based code that may be used to validate the virtual hologram 116. In response to the request, the virtual machine service provider 102 may retrieve the virtual hologram seed associated with the website 114 and, based on the present time interval or timestep, calculate an expected OTP or other time-based code for the website 404. If the OTP or other time-based code provided in the request does not match this expected OTP or other time-based code, the virtual machine service provider 102 may automatically determine that the scanned virtual hologram 116 is not valid. Accordingly, the virtual machine service provider 102 may transmit a response to the other computing device to indicate that the scanned virtual hologram 116 could not be validated. This may serve as an indication to the user that the website 404 being presented through the browser application 402 could not be authenticated or is otherwise not legitimate.

If the virtual machine service provider 102 determines that the provided OTP or other time-based code matches the expected OTP or other time-based code calculated by the virtual machine service provider 102 for the website 404, the virtual machine service provider 102 may transmit a notification to the other computing device to indicate that the virtual hologram 116 is valid. Accordingly, the other computing device, through the application provided by the virtual machine service provider 102 or through the browser application through which the authentication website associated with the virtual machine service provider 102 was accessed, may indicate that the virtual hologram 116 is valid and that as a result the website 404 is authentic and legitimate.

As noted above, the virtual hologram 116 is dynamically generated using the virtual hologram seed associated with the website 404 and an initial time corresponding to a present time interval or timestep. Accordingly, the virtual machine service provider 102 may dynamically monitor the present time to determine when a new time interval or timestep is initiated. When the virtual machine service provider 102 detects that a new time interval or timestep has started, the virtual machine service provider 102 may dynamically and in real-time or near-time generate a new OTP or other time-based code for the website 404. This new OTP or other time-based code may be used by the virtual machine service provider 102 to generate a new virtual hologram 116 that may be presented through the inline frame 406 of the website 404. Accordingly, at new time intervals or timesteps, the virtual hologram 116 may be dynamically updated in real-time or near real-time and presented through the inline frame 406. This may prevent spoofing of the virtual hologram 116 by unauthorized entities, as these unauthorized entities may not have access to the virtual hologram seed.

In an embodiment, when the virtual machine service provider 102 detects that a new time interval or timestep has started, the virtual machine service provider 102 dynamically changes the position of the virtual hologram 116 within the website 404. For example, as illustrated in FIG. 4B, at the beginning of the timestep T₁, the virtual machine service provider 102 may dynamically shift the position of the virtual hologram 116 within the website 404 from the initial position of the inline frame 406 to a new position 408-1 on the website 404. At the beginning of timestep T₂, the virtual machine service provider 102 may again dynamically shift the position of the virtual hologram 116 within the website 404 from the position 408-1 to the position 408-2 on the website 404. Further, at the beginning of timestep T₃, the virtual machine service provider 102 may again dynamically shift the position of the virtual hologram 116 within the website 404 from the position 408-2 to the position 408-3 on the website 404. The virtual hologram 116, at timestep T₄, may return to the initial position of the inline frame 406. This pattern of movement may continue as new time intervals or timesteps are initiated.

In an embodiment, the pattern in which the virtual hologram 116 may be moved or shifted within the website 404 is defined by the virtual machine service provider 102 such that the pattern is undetectable by an entity accessing the website 404. For instance, in addition to generating a virtual hologram seed for the website 404, the virtual machine service provider 102 may dynamically generate a virtual hologram movement algorithm that may be used to determine movements for the virtual hologram 116 within the website 404, as well as the time intervals for movement of the virtual hologram 116 within the website 404. The time intervals for movement of the virtual hologram 116 within the website 404 may be synchronous or asynchronous with the time intervals at which the virtual hologram 116 is dynamically updated using the virtual hologram seed. For instance, the movement of the virtual hologram 116 within the website 404 may be performed at different time intervals to those used to apply the virtual hologram seed for dynamically updating the virtual hologram 116 presented through the website 404. Alternatively, the movement and updating of the virtual hologram 116 within the website 404 may be performed at the same time intervals.

In some instances, the virtual machine service provider 102 may apply one or more animation effects to the virtual hologram 116 at different time intervals to further demonstrate the dynamic nature of the virtual hologram 116 on the website 404. For instance, the virtual machine service provider 102 may implement an animation effect whereby the virtual hologram 116, on the website 404, may rotate along an axis (e.g., horizontal, vertical, arbitrary, etc.) at different time intervals. As another illustrative example, the virtual machine service provider 102 may implement an animation effect whereby the shape of the virtual hologram 116 may be automatically distorted in different directions at different time intervals and subsequently returned to its original shape. Other animation effects may be implemented that may cause changes to the color of the virtual hologram 116, changes to the opaqueness or transparency of the virtual hologram 116, addition of other images or graphical elements, and the like.

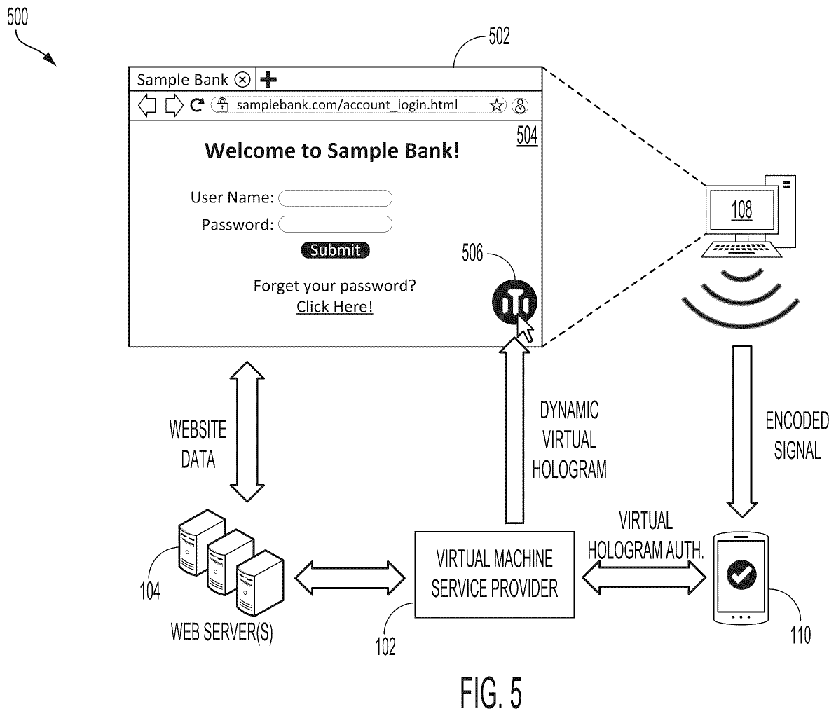

FIG. 5 shows an illustrative example of an environment 500 in which a virtual machine service provider 102 dynamically generates a virtual hologram 506 that encodes executable instructions that, when executed by a computing device 108, causes the computing device 108 to emit a wireless signal usable to authenticate a website 504 in accordance with at least one embodiment. In the environment 500, the virtual machine service provider 102 may dynamically generate a virtual hologram 506 that encodes executable instructions that, as a result of being executed by a computing device 108, cause the computing device 108 to transmit a wireless signal through one or more communications protocols. For instance, the computing device 108 and an authentication device 110 (e.g., a mobile computing device, etc.) may establish a secure communications session using a short-range wireless technology, such as Bluetooth® or Near-Field Communication (NFC) protocols. In some instances, if the computing device 108 implements one or more wireless network protocols (e.g., Wi-Fi, etc.), the authentication device 110 may access a wireless network associated with the computing device 108 subject to these one or more wireless protocols.

Similar to the processes described herein with connection to FIGS. 1-4, the virtual machine service provider 102 may generate the virtual hologram 506 in response to a request from the browser application 502 implemented on the user's computing device 108 to obtain a virtual hologram 506 that may be presented through the website 504. For instance, when the user through the browser application 502 installed on their computing device 108, submits a URI corresponding to the website 504, the web servers 104 associated with the website 504 may provide the web DOM and other web assets that may be used to render the website 504 through the browser application 502. The website 504 may include executable code that, when executed by the browser application 502, may cause the browser application 502 to submit a request to the virtual machine service provider 102 to authenticate the website 504 and provide a virtual hologram 506 that may be used to verify the authenticity of the website 504. The request from the browser application 502 may include the URI associated with the website 504 as well as any other characteristics or parameters associated with the website 504 that may be used to authenticate the website 504.

In response to the request from the browser application 502, the virtual machine service provider 102 may evaluate the URI associated with the website 504, as well as any other provided characteristics or parameters associated with the website 504, to determine whether the website 504 is authentic. As noted above, the virtual machine service provider 102 may determine if the URI of the website 504 and/or any of the provided characteristics or parameters include one or more elements that may be indicative of a suspicious website (e.g., the website is known to include malware, the website includes interaction elements that may lead to the installation of malware, the website is tied to a suspicious entity, the website is a phishing site, etc.). In some instances, to make this determination, the virtual machine service provider 102 may process the provided URI and any other characteristics or parameters associated with the website 504 through a trained machine learning algorithm, as described above. The output of the trained machine learning algorithm may include an indication of whether the website 504 includes any suspicious elements that can be indicative of spoofing or other imitation of a legitimate website. In some instances, the output of the trained machine learning algorithm may indicate whether the website 504 contains any suspicious elements and, thus, should not be authenticated (e.g., the website is known to include malware, the website includes interaction elements that may lead to the installation of malware, the website is tied to a suspicious entity, the website is a phishing site, etc.).

If the virtual machine service provider 102 determines that the website 504 cannot be authenticated, the virtual machine service provider 102 may transmit a notification to the browser application 502 to indicate that the request to obtain a virtual hologram 506 for presentation in conjunction with the website 504 could not be fulfilled. In some instances, the virtual machine service provider 102 may provide content that may be presented by the browser application 502 in conjunction with the website 504 and that provides a graphical indication of the inability of the virtual machine service provider 102 to authenticate the website 504. Additionally, or alternatively, the virtual machine service provider 102 may automatically determine whether there is a legitimate website that can be presented to the user through the browser application 502. If an analogous legitimate website is identified, the virtual machine service provider 102 may automatically re-direct the user to a virtual machine instance instantiated by the virtual machine service provider 102 and through which the user may access the legitimate website. The virtual machine instance may dynamically encode the legitimate website into a data stream that may be transmitted to the browser application 502. The browser application 502 may dynamically decode this data stream to generate a graphical facsimile of the legitimate website that may be presented to the user through the browser application 502, as described above.

If the virtual machine service provider 102 determines that the website 504 is authentic and legitimate, the virtual machine service provider 102 may dynamically generate an OTP or other time-based code using a virtual hologram seed associated with the website 504 and an initial time corresponding to the time interval or timestep during which the request was received. The virtual machine service provider 102 may encrypt the OTP or other time-based code, as well as any required characteristics/parameters of the website 504 (e.g., website URI, the name of the internet-based service associated with the website 504, to generate encrypted authentication information that may be used to authenticate the website 504.

In an embodiment, the virtual machine service provider 102 provides the encrypted authentication information and executable instructions that, when executed by the browser application 502, may cause the browser application 502 to present the virtual hologram 506. The virtual hologram 506, as illustrated in FIG. 5, is an interactable element (e.g., a graphical button, an icon, etc.) that, when selected, may cause the browser application 502 to execute a set of executable instructions provided by the virtual machine service provider 102 for verifying the authenticity of the website 504. For example, when the virtual hologram 506 is presented through the browser application 502 in conjunction with the website 504, the user may select the virtual hologram 506 to verify the authenticity of the website 504. In response to the user's selection of the virtual hologram 506, the browser application 502 may execute the set of executable instructions, which may cause the browser application 502 to update an interface (e.g., a GUI) of the browser application 502 to provide the user with a set of instructions for verifying the authenticity of the website 504. For example, if the encrypted authentication information is to be provided through a wireless signal through one or more communications protocols, the browser application 502 may update the interface to provider the user with an instruction to enable an authentication device 110 that may receive the wireless signal. Once the authentication device 110 has been enabled, the browser application 502 may cause the computing device 108 to establish a secure communications session through use of the one or more communications protocols.

In an embodiment, once the browser application 502 detects that a secure communications session has been established between the computing device 108 and the authentication device 110, the browser application 502 may transmit a wireless signal that encodes the encrypted authentication information associated with the website 504. Additionally, the browser application 502 may transmit additional executable instructions that, when executed by the authentication device 110, may cause the authentication device 110 to execute an application implemented by the virtual machine service provider 102 for decrypting the encrypted authentication information for verifying the authenticity of the website 504. In some instances, if the application is not installed on the authentication device 110, the executable instructions may cause the authentication device 110 to obtain the application from the virtual machine service provider 102 and install the application on to the authentication device 110.

In some instances, the application provided by the virtual machine service provider 102, in response to receiving the wireless signal from the computing device 108, may decode the wireless signal to obtain the encrypted authentication information associated with the website 504. In response to obtaining the encrypted authentication information, the application, through one or more APIs exposed by the virtual machine service provider 102, may transmit a request to the virtual machine service provider 102 to decrypt the encrypted authentication information and to verify the authenticity of the website 504. In some instances, the application may maintain a cryptographic key that may be used to dynamically decrypt the encrypted authentication information in order to obtain the OTP or other time-based code generated by the virtual machine service provider 102 and the characteristics/parameters of the website 504 that may be used to authenticate the website 504. Accordingly, the application, through the one or more APIs exposed by the virtual machine service provider 102, may transmit a request to the virtual machine service provider 102 to validate the OTP or other time-based code.

In response to the request from the authentication device 110, the virtual machine service provider 102 may determine whether the provided OTP or other time-based code is valid. If the authentication device 110 provided encrypted authentication information to the virtual machine service provider 102 in lieu of the decrypted OTP or other time-based code, the virtual machine service provider 102 may determine whether the encrypted authentication information may be decrypted to obtain the OTP or other time-based code associated with the website 504. If the virtual machine service provider 102 is unable to decrypt the encrypted authentication information (e.g., the virtual machine service provider 102 does not maintain a cryptographic key usable to decrypt the encrypted authentication information, etc.), the virtual machine service provider 102 may determine that the virtual hologram 506 cannot be validated. Accordingly, the virtual machine service provider 102 may transmit a response to the authentication device 110 to indicate that the website 504 could not be authenticated.

If the virtual machine service provider 102 obtains the OTP or other time-based code from the encrypted authentication information or directly from the request submitted by the application implemented on the authentication device 110, the virtual machine service provider 102 may query the virtual hologram seed datastore using the characteristics/parameters associated with the website 504 to determine whether a virtual hologram seed is available for the website 504. If the virtual machine service provider 102 is unable to identify a virtual hologram seed corresponding to the website 504, the virtual machine service provider 102 may transmit a response to the request from the authentication device 110 to indicate that the website 504 could not be authenticated. Alternatively, if the virtual machine service provider 102 identifies a virtual hologram seed associated with the website 504 based on the provided characteristics/parameters associated with the website 504, the virtual machine service provider 102 may use the virtual hologram seed and the initial time for the time interval or timestep corresponding to the time at which the website 504 was accessed to generate an expected OTP or other time-based code.

The virtual machine service provider 102 may compare the OTP or other time-based code provided by the application implemented on the authentication device 110 to the expected OTP or other time-based code generated using the virtual hologram seed. If the OTP or other time-based code provided by the authentication device 110 differs from the expected OTP or other time-based code generated using the virtual hologram seed, the virtual machine service provider 102 may determine that the virtual hologram 506 being presented to the user through the website 504 is not valid. Accordingly, the virtual machine service provider 102 may transmit a notification to the user, through the application implemented on the authentication device 110, to indicate that the website 504 could not be authenticated. However, if the virtual machine service provider 102 determines that the provided OTP or other time-based code matches the expected OTP or other time-based code generated using the virtual hologram seed, the virtual machine service provider 102 may determine that the website 504 is authentic. Accordingly, the virtual machine service provider 102 may transmit a notification to the user, through the application implemented on the authentication device 110, to indicate that the website 504 is authentic and legitimate.

As noted above, the OTP or other time-based code (and, accordingly, the virtual hologram 506) may be dynamically updated according to a pre-defined time interval or timestep. For instance, at each time interval or timestep, the virtual machine service provider 102 may use the virtual hologram seed and the initial time for the present time interval or timestep as input to the aforementioned hash function or other cryptographic algorithm to generate a new OTP or other time-based code. The virtual machine service provider 102 may encrypt the new OTP or other time-based code, as well as any required characteristics/parameters of the website 504, to generate new encrypted authentication information. When the user selects the virtual hologram 506 to verify the authenticity of the website 504, the browser application 502 may transmit a new wireless signal that encodes the new encrypted authentication information associated with the website 504. In some instances, if the secure communications session between the computing device 108 and the authentication device 110 is active, the browser application 502 may automatically transmit, through the computing device 108, the new wireless signal encoding the new encrypted authentication information. Thus, the authentication device 110 may continuously receive the latest encrypted authentication information associated with the website 504 for authentication of the website 504.

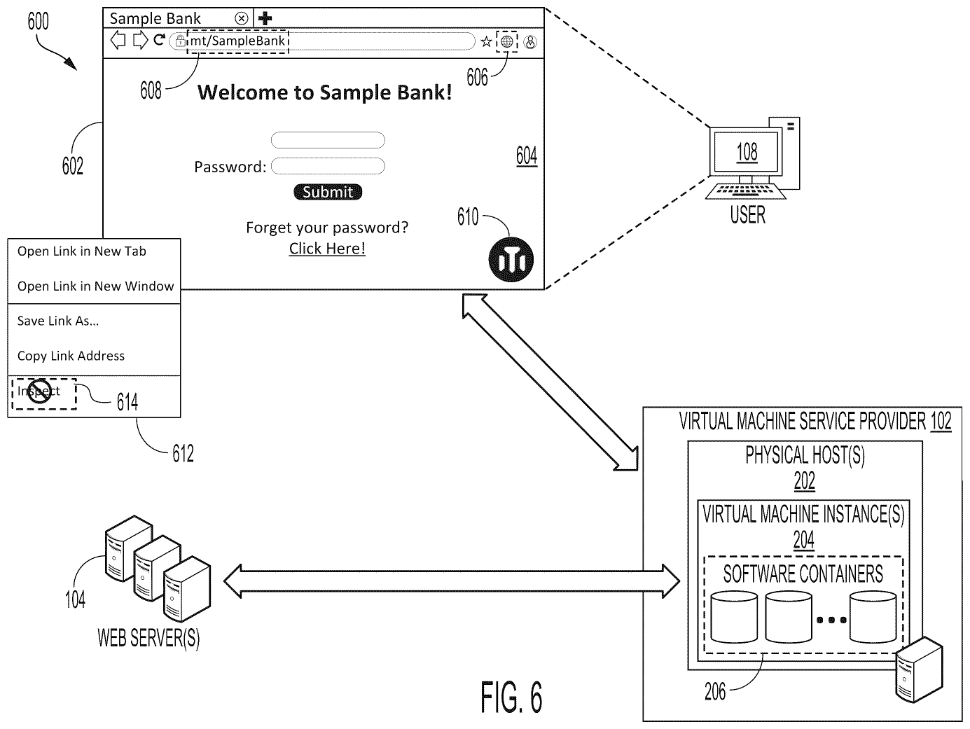

FIG. 6 shows an illustrative example of an environment 600 in which a browser extension application 606 associated with a virtual machine service provider 102 converts one or more keywords corresponding to a website 604 to a URI corresponding to a virtual machine instance 204 through which the website 604 can be accessed in accordance with at least one embodiment. In the environment 600, the virtual machine service provider 102 can provide, to users, a browser extension application 606 that may be installed on a computing device and executed when a browser application 602 on the computing device is executed. The browser extension application 606, in an embodiment, maintains a repository of commands that are associated with URIs of different websites that have been vetted by the virtual machine service provider 102 and that may be rendered through a virtual machine instance 204 instantiated by the virtual machine service provider 102.

A command 608 associated with the browser extension application 606 may include a predicate and one or more keywords. For example, as illustrated in FIG. 6, the command 608 “mt/SampleBank” includes the predicate “mt/” and the keyword “SampleBank.” The predicate “mt/” may serve as an indication that the user has entered, through the address bar of the browser application 602, a command that is to be processed by the browser extension application 606. When a user enters any text into the address bar (e.g., URIs or non-URIs), the browser extension application 606 may automatically process the text to determine whether the text includes the required predicate (e.g., “mt/”). If the browser extension application 606 determines that the text entered into the address bar does not include the required predicate, the browser extension application 606 may pass the text to the browser application 602, which may process the text accordingly (e.g., transmit an entered URI to one or more DNS servers, automatically redirect the user to a search engine for an entered non-URI, etc.).

If the browser extension application 606 determines that the entered text is a command 608 that may be processed by the browser extension application 606 (e.g., the command 608 includes the predicate “mt/”), the browser extension application 606 may evaluate the one or more keywords included in the command 608 to determine whether these one or more keywords are associated with a URI of a website that has been vetted by the virtual machine service provider 102 and that may accordingly be rendered through a virtual machine instance 204. For example, for the command 608 “mt/SampleBank” entered into the address bar of the browser application 602, the browser extension application 606 may determine whether the keyword “SampleBank” is associated with an existing URI of a website that has been vetted by the virtual machine service provider 102. For example, the browser extension application 606 may query its repository of known commands to determine whether the entered keyword “SampleBank” is associated with a URI of a vetted website. In some instances, the browser extension application 606, through one or more APIs exposed by the virtual machine service provider 102, may transmit an API call to the virtual machine service provider 102 to determine whether the entered keyword is associated with a URI of a vetted website. This API call to the virtual machine service provider 102 may be transmitted automatically if the browser extension application 606 determines that it does not maintain an entry corresponding to the submitted one or more keywords in its command repository.

In an embodiment, if the browser extension application 606 determines that the command 608 is not associated with a URI corresponding to a vetted website, the browser extension application 606 may provide the user, through the browser application 602, with an error message. For example, the browser extension application 606, through the browser application 602, may present the user with a HyperText Transfer Protocol (HTTP) 404 error message, which may serve as an indication that a website corresponding to the URI entered into the address bar could not be found. In some instances, the browser extension application 606, through the browser application 602, may provide a more detailed error message corresponding to the entered command 608. For example, the browser extension application 606, through the browser application 602, may explicitly indicate that the entered command 608 is not associated with a website vetted by the virtual machine service provider 102.

If the browser extension application 606 determines that the command 608 is associated with a URI of a vetted website (either through an evaluation of its command repository or as indicated by the virtual machine service provider 102 in response to the API call), the browser extension application 606 may automatically transmit a request to the virtual machine service provider 102 to instantiate a virtual machine instance 204 through which the website 604 corresponding to the URI can be rendered and encoded into a data stream. As noted above, the virtual machine service provider 102 may implement a set of physical hosts 202 that may be used to instantiate different virtual machine instances 204 through which virtual browser application environments may be executed. A virtual machine instance 204 may be implemented using a virtual machine image according to a website administrator's configuration requirements. The virtual machine instance 204 may be instantiated as a container instance that is configured to operate myriad software containers 206 according to the parameters of the virtual machine image, as described above.

In response to the request from the browser extension application 606, the virtual machine service provider 102 may instantiate a virtual machine instance 204 through which a virtual environment may be implemented for rendering and encoding of the website 604, as described above. For instance, the virtual machine instance 204 may automatically, and in real-time, encode the web DOM associated with website 604 into a data structure that obfuscates the web DOM associated with the website 604 but that may be decoded by computing devices to allow for presentation of a graphical facsimile of the website 604. This graphical facsimile of the website may be presented to users without exposure of the web DOM associated with the website 604, as the graphical facsimile of the website 604 is generated using an alternative data structure that does not include the web DOM associated with the website 604. In an embodiment, the virtual machine instance 204 includes one or more software containers 206 that include one or more applications or programs that can automatically encode the web DOM associated with the website 604 and generate a graphical facsimile of the website 604 in real-time that may be provided to users attempting to access the website 604.

In addition to instantiating a virtual machine instance 204 through which the virtual environment may be implemented for rendering and encoding the website 604, the virtual machine instance 204 may automatically access the one or more web servers 104 associated with the website 604 to obtain the web DOM and other assets associated with the website 604 for encoding into the graphical facsimile of the website 604. For instance, in response to the request from the browser extension application 606, the virtual machine instance 204 may automatically, and in real-time, query the one or more web servers 104 associated with the website 604 to obtain the web DOM and any other assets that may be used to render the website 604. The virtual machine instance 204, using the one or more software containers 206 described above and implemented therein, may automatically process the web DOM and the other assets to generate a graphical facsimile of the website 604 that may be streamed to the browser application 602. For instance, if using a default encoding mechanism (e.g., one or more WebRTC protocols, a VNC protocol, etc.), the one or more software containers 206 may encode one or more portions of the web DOM associated with the particular website 604 into individual pixels that may be pushed or transmitted in a binary stream to the browser application 602. Alternatively, if the virtual machine service provider 102 implements a custom encoder for encoding of the one or more portions of the web DOM associated with the particular website 604 for delivery of the graphical facsimile of the website 604 to the user, the one or more software containers 206 may process the web DOM associated with the particular website 604 using the custom encoder to generate an encoding in a data format that may be compressed, encrypted, and transmitted to the browser application 602 for presentation of a graphical facsimile of the website 604.

As the virtual machine instance 204 encodes the web DOM and the various assets associated with the website 604 according to either the default encoding method (e.g., one or more WebRTC protocols, a VNC protocol, etc.) or the custom encoding method defined by the virtual machine service provider 102, the virtual machine instance 204 may push or transmit, in real-time, a data stream that includes the encoded graphical facsimile of the website 604. The browser application 602 may automatically, and in real-time, decode the encoded graphical facsimile of the website 604 and present the graphical facsimile of the website 604. The graphical facsimile of the website 604 may appear identical to the original website with some notable exceptions. For example, as illustrated in FIG. 6, if the user accesses, through the browser application 602, a browser menu 612 corresponding to the presented graphical facsimile of the website 604, the option 614 to inspect the website may be disabled such that the user is prohibited from inspecting the website 604 being presented to the user. For instance, since the website 604 presented through the browser application 602 is actually a graphical facsimile of the website 604, the browser application 602 may automatically disable the option 614 to inspect the website 604. In some instances, in addition to pushing or transmitting the data stream that includes the encoded graphical facsimile of the website 604, the virtual machine instance 204 may transmit executable instructions to the browser application 602 to disable this option 614 to inspect the website 604. It should be noted that while an option 614 to inspect the website 604 is illustrated in FIG. 6 and used extensively throughout the present disclosure for the purpose of illustration, other options that may otherwise be made available to users accessing the website 604 (e.g., an option to save the website 604 as a document, an option to add or otherwise install other browser extensions, etc.) may also be automatically disabled.

In an embodiment, the virtual machine instance 204 may further provide a virtual hologram 610 that may be used to verify that the website 604 has been authenticated by the virtual machine service provider 102. As noted above, the virtual hologram 610 may encode an OTP or other time-based code, as well as the one or more characteristics or parameters associated with the website 604 (e.g., the name of the internet-based service associated with the website 604, the URI corresponding to the website 604, country of registration, website domain age, etc.). The virtual hologram 610 may further encode a URI corresponding to a website implemented by the virtual machine service provider 102 and through which the user of the browser application 602 may obtain additional information regarding the authenticity of the website 604.

As noted above, the user of the browser application 602, using an authentication device, may scan the graphical representation of the virtual hologram 610 to determine whether the website is authentic. The authentication device may use the URI encoded in the virtual hologram 610 or one or more APIs exposed by the virtual machine service provider 102 to transmit a request to the virtual machine service provider 102 to determine whether the website 604 is authentic. The request may include the one or more characteristics or parameters associated with the website 604 and the OTP or other time-based code that may be used to authenticate the website 604. In response to the request, the virtual machine service provider 102 may determine whether the provided OTP or other time-based code is valid. If the virtual machine service provider 102 is unable to validate the provided OTP or other time-based code, the virtual machine service provider 102 may transmit a response to the request indicating that the website 604 could not be authenticated. However, if the virtual machine service provider 102 determines that the provided OTP or other time-based code matches the expected OTP or other time-based code generated by the virtual machine service provider 102, the virtual machine service provider 102 may determine that the website 604 is authentic. Accordingly, the virtual machine service provider 102 may transmit a notification to the user to indicate that the website 604 has been vetted and that it is authentic.

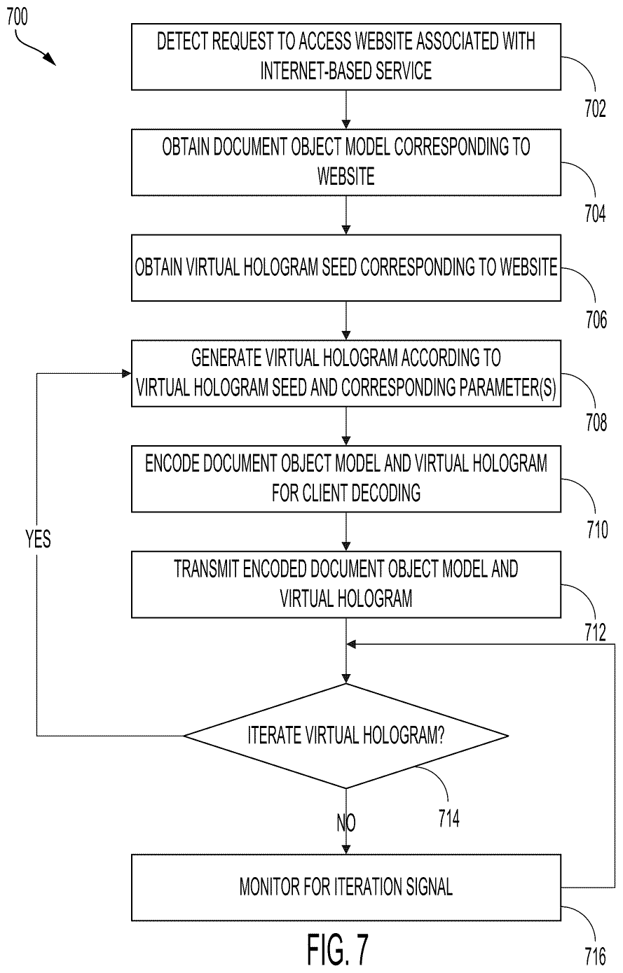

FIG. 7 shows an illustrative example of a process 700 for encoding a web DOM corresponding to a website and a virtual hologram usable to authenticate the website into a data stream for presentation of the website and the virtual hologram in accordance with at least one embodiment. The process 700 may be performed by the aforementioned virtual machine service provider, which may provision a virtual machine instance that may perform the encoding of the web DOM corresponding to the website and the virtual hologram into a data stream as described in greater detail herein. Further, the virtual machine service provider may leverage a virtual hologram generator (such as virtual hologram generator 208 described above in connection with FIGS. 2-3) to dynamically generate the virtual hologram.

At step 702, the virtual machine service provider may detect a request to access a website associated with an internet-based service. For instance, when a user, through a browser application implemented on their computing device, submits a request to access the website, the browser application may transmit a request to one or more DNS servers to obtain the IP address corresponding to the website. In response to this request, the one or more DNS servers may return an IP address corresponding to the virtual machine service provider. Using this IP address, the browser application may transmit a request to the virtual machine service provider to access the website.

In response to the request from the browser application, the virtual machine service provider, at step 704, may obtain the web DOM and other assets associated with the website that may be used to render the website. For instance, the virtual machine service provider may automatically, and in real-time, query one or more web servers associated with the website to obtain the web DOM and any other assets that may be used to render the website. In some instances, prior to obtaining the web DOM and other assets associated with the website, the virtual machine service provider may evaluate the URI associated with the website to determine whether the website is authentic. For instance, if the URI associated with the website is suspicious in nature (e.g., the website is known to include malware, the website includes interaction elements that may lead to the installation of malware, the website is tied to a suspicious entity, the website is a phishing site, etc.), the virtual machine service provider may determine whether there is a legitimate website that can be presented to the user. For example, the virtual machine service provider may process the URI associated with the website against a repository of known URIs for legitimate websites to determine whether a legitimate website can be identified. IF a legitimate website is identified, the virtual machine service provider may obtain the web DOM and other assets associated with the legitimate website that may be used to instead render the legitimate website.

At step 706, the virtual machine service provider, through the virtual hologram generator, may obtain a virtual hologram seed corresponding to website to dynamically generate, at step 708, a virtual hologram according to the virtual hologram seed and a set of characteristics and/or parameters associated with the website. For instance, the virtual hologram generator may query a virtual hologram seed datastore maintained by the virtual machine service provider to determine whether a virtual hologram seed corresponding to the website is available. If the virtual hologram seed datastore does not maintain a virtual hologram seed corresponding to the website, the virtual hologram generator may automatically generate or otherwise provision the virtual hologram seed for the website. Using the virtual hologram seed associated with the website, the virtual hologram generator may dynamically generate a virtual hologram that may be used to authenticate the website. The virtual hologram may encode an OTP or other time-based code that may be used to authenticate the virtual hologram and the website. This OTP or other time-based code may be generated using the virtual hologram seed and an initial time corresponding to a time interval or timestep determined based on when the request to access the website was received.

At step 710, the virtual machine instance provisioned for the website may encode the virtual hologram, the web DOM associated with the website, and the assets associated with the website into a data stream that may be transmitted to the user for client decoding. For instance, the virtual machine instance may automatically process the virtual hologram, the web DOM, and the other assets to generate a graphical facsimile of the virtual hologram and of the website that may be streamed to the user in response to their request. For instance, if using a default encoding mechanism (e.g., one or more WebRTC protocols, a VNC protocol, etc.), the virtual machine instance may encode the virtual hologram and one or more portions of the web DOM associated with the particular website into individual pixels that may be pushed or transmitted in a binary stream to the browser application. Alternatively, if the virtual machine service provider implements a custom encoder for encoding of the one or more portions of the web DOM associated with the particular website for delivery of the graphical facsimile of the website to the user, the virtual machine instance may process the virtual hologram and the web DOM associated with the particular website using the custom encoder to generate an encoding in a data format that may be compressed, encrypted, and transmitted to the browser application for presentation of a graphical facsimile of the virtual hologram and of the website.

At step 712, the virtual machine instance may transmit the encoded virtual hologram and the web DOM associated with the website to the browser application. For instance, as the virtual machine instance encodes the virtual hologram, the web DOM, and the various assets associated with the website according to either the default encoding method (e.g., one or more WebRTC protocols, a VNC protocol, etc.) or the custom encoding method defined by the virtual machine service provider, the virtual machine instance may push or transmit, in real-time, a data stream that includes the encoded graphical facsimile of the virtual hologram and of the website. The browser application may automatically, and in real-time, decode the encoded graphical facsimile of the virtual hologram and of the website and present the graphical facsimiles of the virtual hologram and the website.

At step 714, the virtual machine service provider may determine whether to iterate the virtual hologram for generation of a new virtual hologram that may be used to authenticate the website. As noted above, the OTP or other time-based code (and, accordingly, the virtual hologram) may be dynamically updated according to a pre-defined time interval or timestep. Thus, the virtual machine service provider may continuously monitor the user's access to the website through the virtual machine instance to detect an iteration signal that may serve as an indication that the virtual hologram is to be updated. The iteration signal may correspond to detection of the end of a present time interval or timestep for the virtual hologram. If the virtual machine service provider determines that the virtual hologram needs to be iterated, the virtual machine service provider, through the virtual hologram generator may, at step 708, generate a new virtual hologram according to the virtual hologram seed and the new initial time for the new time interval or timestep. For instance, at each time interval or timestep, the virtual hologram generator may use the virtual hologram seed and the initial time for the present time interval or timestep as input to the aforementioned hash function or other cryptographic algorithm to generate a new OTP or other time-based code. Using the new OTP or other time-based code, as well as the one or more characteristics or parameters associated with the website, the virtual hologram generator may generate a new virtual hologram that encodes the newly generated OTP/time-based code and the characteristics/parameters associated with the website. In between time intervals or timesteps, the virtual machine service provider, at step 716, may continuously monitor for an iteration signal that may indicate a need to generate a new virtual hologram.

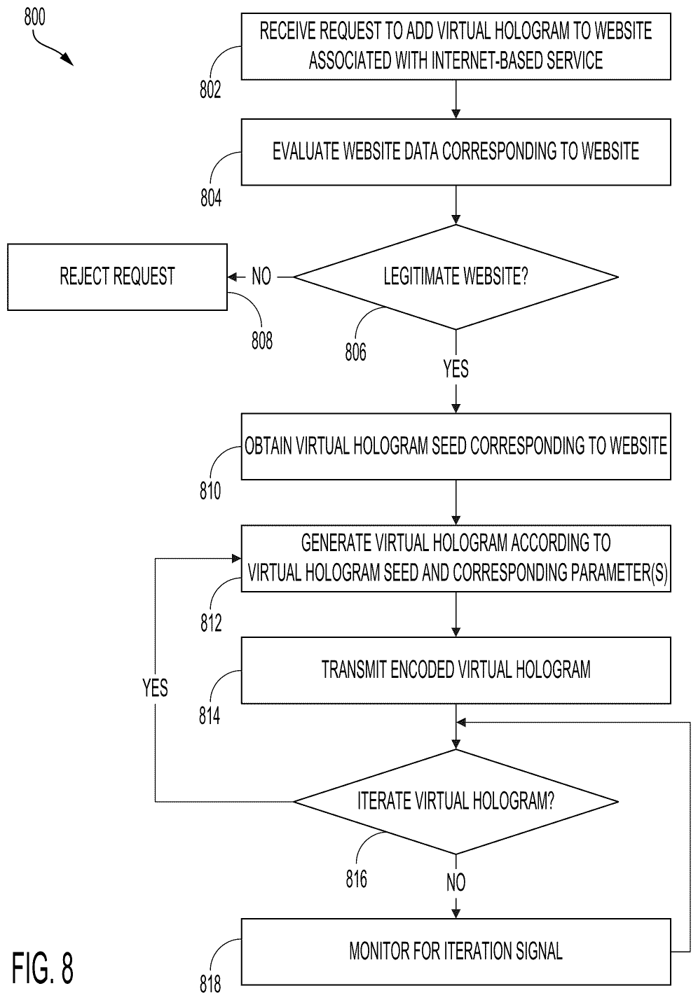

FIG. 8 shows an illustrative example of a process 800 for adding a virtual hologram to a website associated with an internet-based service for use in authenticating the website in accordance with at least one embodiment. Similar to the process 700 described above in connection with FIG. 7, the process 800 may be performed by the aforementioned virtual machine service provider, which may provision a virtual machine instance that may perform the encoding of the virtual hologram into a data stream as described in greater detail herein. Further, the virtual machine service provider may leverage a virtual hologram generator (such as virtual hologram generator 208 described above in connection with FIGS. 2-3) to dynamically generate the virtual hologram.

At step 802, the virtual machine service provider may receive a request add a virtual hologram to a website associated with an internet-based service. As noted above, in some instances, a website may include an inline frame or other element that may be reserved for the presentation of a virtual hologram that may be used for authentication of the website. This inline frame or other element may include a URI corresponding to the virtual machine service provider, which a browser application may automatically utilize to access the virtual machine service provider to request authentication of the website and generation of a virtual hologram that may be presented through the inline frame or other element to allow users to verify the authenticity of the website. In some instances, this inline frame or other elements may include executable code that, when executed by the browser application, may cause the browser application to transmit, through one or more APIs exposed by the virtual machine service provider, an API call to the virtual machine service provider to request generation of the virtual hologram. The request from the browser application may include the URI associated with the website as well as any other characteristics or parameters associated with the website that may be used by the virtual machine service provider to authenticate the website.

At step 804, the virtual machine service provider may evaluate the website data (e.g., URI and other characteristics or parameters associated with the website) to determine, at step 806, whether the website being presented through the browser application is legitimate. For instance, the virtual machine service provider may determine if the URI of the website and/or any of the provided characteristics or parameters include one or more elements that may be indicative of a suspicious website (e.g., the website is known to include malware, the website includes interaction elements that may lead to the installation of malware, the website is tied to a suspicious entity, the website is a phishing site, etc.). In some instances, to make this determination, the virtual machine service provider may process the provided URI and any other characteristics or parameters associated with the website through a trained machine learning algorithm, as described above. The output of the trained machine learning algorithm may include an indication of whether the website includes any suspicious elements that can be indicative of spoofing or other imitation of a legitimate website. In some instances, the output of the trained machine learning algorithm may indicate whether the website contains any suspicious elements and, thus, should not be authenticated (e.g., the website is known to include malware, the website includes interaction elements that may lead to the installation of malware, the website is tied to a suspicious entity, the website is a phishing site, etc.).

If the virtual machine service provider determines that the website cannot be authenticated (e.g., the website is not legitimate, the website contains suspicious elements, etc.), the virtual machine service provider, at step 808, may reject the request to obtain a virtual hologram that may be presented in conjunction with the website. As noted above, when the request is rejected, the virtual machine service provider may transmit a notification to the browser application to indicate that the website could not be authenticated. Since this notification does not include a virtual hologram that may be used by users to authenticate the website, the inline frame or other web element reserved for the presentation of virtual holograms may remain empty or otherwise devoid of any content. This may serve as an indication to the user that the website could not be authenticated by the virtual machine service provider. In some instances, if the website could not be authenticated by the virtual machine service provider, the virtual machine service provider may provide content that may be presented through the inline frame or other web elements and that provides a graphical indication of the inability of the virtual machine service provider to authenticate the website. For instance, through the inline frame or other web element, the virtual machine service provider may present text, images, video, and/or other elements that may be easily processed by a user to determine that the website could not be authenticated.

If the virtual machine service provider determines that the website is legitimate, the virtual machine service provider may obtain a virtual hologram seed corresponding to website to dynamically generate, at step 812, a virtual hologram according to the virtual hologram seed and the set of characteristics and/or parameters associated with the website. For instance, the virtual machine service provider, through the virtual hologram generator, may query a virtual hologram seed datastore maintained by the virtual machine service provider to determine whether a virtual hologram seed corresponding to the website is available. If the virtual hologram seed datastore does not maintain a virtual hologram seed corresponding to the website, the virtual hologram generator may automatically generate or otherwise provision the virtual hologram seed for the website. Using the virtual hologram seed associated with the website, the virtual hologram generator may dynamically generate a virtual hologram that may be used to authenticate the website. The virtual hologram may encode an OTP or other time-based code that may be used to authenticate the virtual hologram and the website. This OTP or other time-based code may be generated using the virtual hologram seed and an initial time corresponding to a time interval or timestep determined based on when the request to access the website was received.

At step 814, the virtual machine service provider may transmit the encoded virtual hologram to the browser application for presentation of the virtual hologram through the inline frame or other web element. In some instances, the virtual machine service provider may dynamically provision a new virtual machine instance through which the virtual hologram may be provided to the browser application for presentation within the inline frame or other web element. The virtual machine instance may encode the virtual hologram from the virtual hologram generator into a data stream that may be transmitted to the browser application. The browser application may automatically decode this data stream to generate a graphical facsimile of the virtual hologram within the inline frame or other web element of the website. Since the virtual hologram is graphically represented using a set of pixels, inspection of the virtual hologram associated with the website is prevented.

Similar to the process 700 described above in connection with FIG. 7, at step 816, the virtual machine service provider may determine whether to iterate the virtual hologram for generation of a new virtual hologram that may be used to authenticate the website. As noted above, the OTP or other time-based code (and, accordingly, the virtual hologram) may be dynamically updated according to a pre-defined time interval or timestep. Thus, the virtual machine service provider may continuously monitor the user's access to the website through the virtual machine instance to detect an iteration signal that may serve as an indication that the virtual hologram is to be updated. The iteration signal may correspond to detection of the end of a present time interval or timestep for the virtual hologram. If the virtual machine service provider determines that the virtual hologram needs to be iterated, the virtual machine service provider, through the virtual hologram generator may, at step 812, generate a new virtual hologram according to the virtual hologram seed and the new initial time for the new time interval or timestep. For instance, at each time interval or timestep, the virtual hologram generator may use the virtual hologram seed and the initial time for the present time interval or timestep as input to the aforementioned hash function or other cryptographic algorithm to generate a new OTP or other time-based code. Using the new OTP or other time-based code, as well as the one or more characteristics or parameters associated with the website, the virtual hologram generator may generate a new virtual hologram that encodes the newly generated OTP/time-based code and the characteristics/parameters associated with the website. In between time intervals or timesteps, the virtual machine service provider, at step 818, may continuously monitor for an iteration signal that may indicate a need to generate a new virtual hologram.

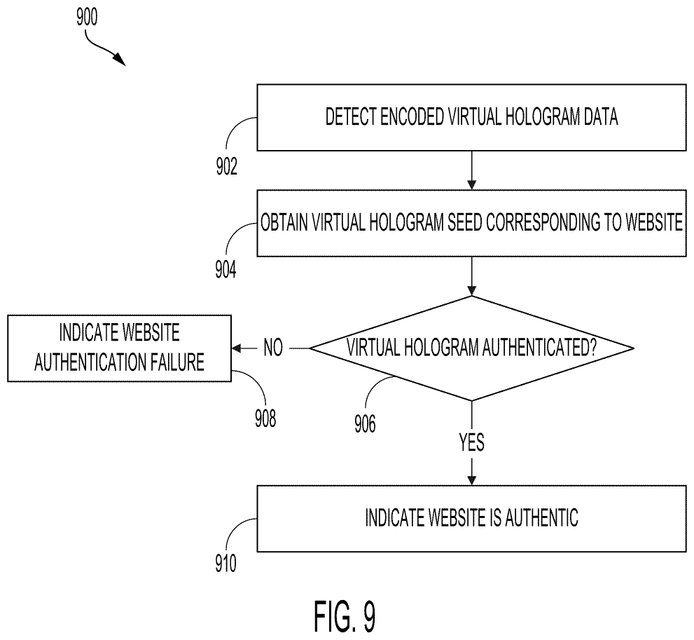

FIG. 9 shows an illustrative example of a process 900 for authenticating a website through evaluation of encoded virtual hologram data from a presented virtual hologram in accordance with at least one embodiment. The process 900 may be performed by a virtual hologram generator implemented by the virtual machine service provider. The virtual hologram generator, as described above, may dynamically generate a virtual hologram that encodes one or more characteristics or parameters associated with a website (e.g., the name of the internet-based service associated with the website, country of registration, website domain age, etc.), a URI corresponding to a website implemented by the virtual machine service provider and through which the user may obtain additional information regarding the authenticity of the website, and an OTP or other time-based code that may be used to authenticate the virtual hologram and the corresponding website. Thus, the virtual hologram generator may perform the authentication of a virtual hologram based on provided virtual hologram data extracted from the virtual hologram.

At step 902, the virtual hologram generator may detect encoded virtual hologram data that is to be evaluated to determine the authenticity of a virtual hologram and a corresponding website through which the virtual hologram is presented. As noted above, a user, using an authentication device, may scan a virtual hologram presented through a website to determine whether the website is authentic. The authentication device may use the URI encoded in the virtual hologram to transmit a request to the virtual hologram generator to determine whether the website is authentic. The request may include (as extracted from the virtual hologram) the one or more characteristics or parameters associated with the website and the OTP or other time-based code that may be used to authenticate the website.

At step 904, the virtual hologram generator may obtain the virtual hologram seed corresponding to the website to determine, at step 906, whether the virtual hologram can be authenticated. For instance, the virtual hologram generator may query the virtual hologram seed datastore using the extracted characteristics/parameters associated with the website to determine whether a virtual hologram seed is available for the website. If the virtual hologram generator is unable to identify a virtual hologram seed corresponding to the website, the virtual hologram generator may determine that the virtual hologram and, thus, the website cannot be authenticated. Accordingly, at step 908, the virtual hologram generator may indicate a website authentication failure. For instance, the virtual hologram generator may transmit a response to the request from the user indicating that the website could not be authenticated.

If the virtual hologram generator identifies a virtual hologram seed associated with the particular website, the virtual hologram generator may use the virtual hologram seed and the initial time for the time interval or timestep corresponding to the time at which the website was accessed to generate an expected OTP or other time-based code. If the OTP or other time-based code provided by the user differs from the expected OTP or other time-based code generated by the virtual hologram generator, the virtual hologram generator may determine that the virtual hologram being presented to the user is not valid. Accordingly, at step 908, the virtual hologram generator may transmit a notification to the user to indicate that the website could not be authenticated. However, if the virtual hologram generator determines that the provided OTP or other time-based code matches the expected OTP or other time-based code generated by the virtual hologram generator, the virtual hologram generator may determine that the website is authentic. Accordingly, at step 910, the virtual hologram generator may transmit a notification to the user to indicate that the website has been vetted and that it is authentic.

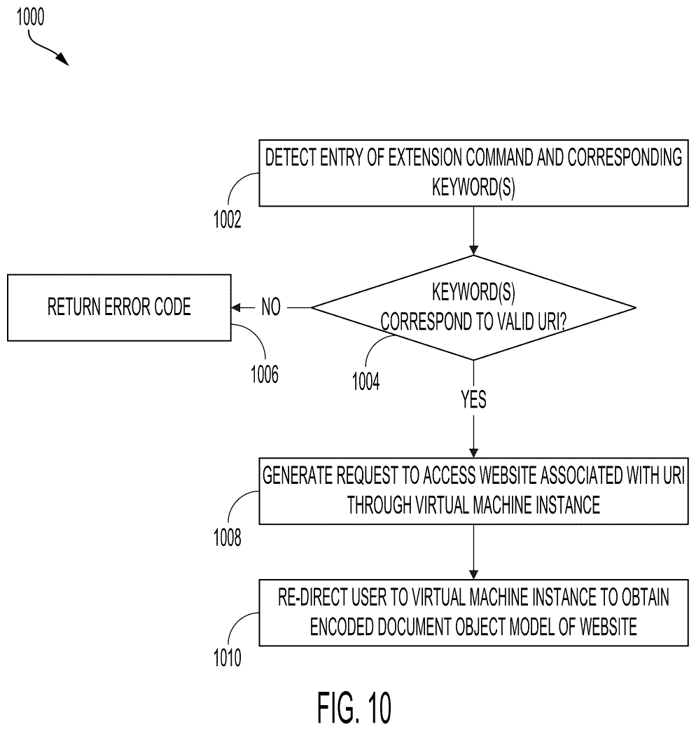

FIG. 10 shows an illustrative example of a process 1000 for executing a browser extension application command and corresponding keywords to generate a request to access a website through a virtual machine instance in accordance with at least one embodiment. The process 1000 may be performed by a browser extension application executed through a browser application and provided by a virtual machine service provider.

At step 1002, the browser extension application may detect entry of an extension command and one or more corresponding keywords. As noted above, an extension command may include a predicate and one or more keywords. For example, the extension command “mt/SampleBank” includes the predicate “mt/” and the keyword “SampleBank.” The predicate “mt/” may serve as an indication that the user has entered, through the address bar of a browser application, a command that is to be processed by the browser extension application. When a user enters any text into the address bar, the browser extension application may automatically process the text to determine whether the text includes the required predicate (e.g., “mt/”).

If the browser extension application determines that the text includes the required predicate, the browser extension application may process the one or more keywords from extension command to determine, at step 1004, whether these one or more keywords correspond to a valid URI of a website. For example, the browser extension application may query its repository of known commands to determine whether the entered one or more keywords are associated with a URI of a vetted website. In some instances, the browser extension application, through one or more APIs exposed by the virtual machine service provider, may transmit an API call to the virtual machine service provider to determine whether the entered one or more keywords are associated with a URI of a vetted website. This API call to the virtual machine service provider may be transmitted automatically if the browser extension application determines that it does not maintain an entry corresponding to the submitted one or more keywords in its command repository.

If the browser extension application determines that the command is not associated with a URI corresponding to a vetted website, the browser extension application, at step 1006, may return an error code to the user. For instance, the browser extension application, through the browser application, may present the user with an HTTP 404 error message, which may serve as an indication that a website corresponding to the URI entered into the address bar could not be found. In some instances, the browser extension application, through the browser application, may provide a more detailed error message corresponding to the entered command. For example, the browser extension application, through the browser application, may explicitly indicate that the entered command is not associated with a website vetted by the virtual machine service provider.

If the browser extension application determines that the command is associated with a URI of a vetted website (either through an evaluation of its command repository or as indicated by the virtual machine service provider in response to the API call), the browser extension application may, at step 1008, automatically generate and transmit a request to the virtual machine service provider to instantiate a virtual machine instance through which the website corresponding to the URI can be accessed. As noted above, the virtual machine service provider may implement a set of physical hosts that may be used to instantiate different virtual machine instances through which virtual browser application environments may be executed. A virtual machine instance may be implemented using a virtual machine image according to a website administrator's configuration requirements. The virtual machine instance may be instantiated as a container instance that is configured to operate myriad software containers according to the parameters of the virtual machine image, as described above.

At step 1010, the browser extension application may re-direct the user to the virtual machine instance, through which the user's browser application may obtain an encoded data stream usable to render a graphical facsimile of the website. As noted above, the virtual machine instance may automatically, and in real-time, encode the web DOM associated with website into a data structure that obfuscates the web DOM associated with the website but that may be decoded by computing devices to allow for presentation of a graphical facsimile of the website. For instance, the virtual machine instance may automatically, and in real-time, query the one or more web servers associated with the website to obtain the web DOM and any other assets that may be used to render the website. The virtual machine instance may automatically process the web DOM and the other assets to generate a graphical facsimile of the website that may be streamed to the browser application. For instance, if using a default encoding mechanism (e.g., one or more WebRTC protocols, a VNC protocol, etc.), the virtual machine instance may encode one or more portions of the web DOM associated with the particular website into individual pixels that may be pushed or transmitted in a binary stream to the browser application. Alternatively, if the virtual machine service provider implements a custom encoder for encoding of the one or more portions of the web DOM associated with the particular website for delivery of the graphical facsimile of the website to the user, the virtual machine instance may process the web DOM associated with the particular website using the custom encoder to generate an encoding in a data format that may be compressed, encrypted, and transmitted to the browser application for presentation of a graphical facsimile of the website. As the virtual machine instance encodes the web DOM and the various assets associated with the website according to either the default encoding method (e.g., one or more WebRTC protocols, a VNC protocol, etc.) or the custom encoding method defined by the virtual machine service provider, the virtual machine instance may push or transmit, in real-time, a data stream that includes the encoded graphical facsimile of the website. The browser application may automatically, and in real-time, decode the encoded graphical facsimile of the website and present the graphical facsimile of the website.

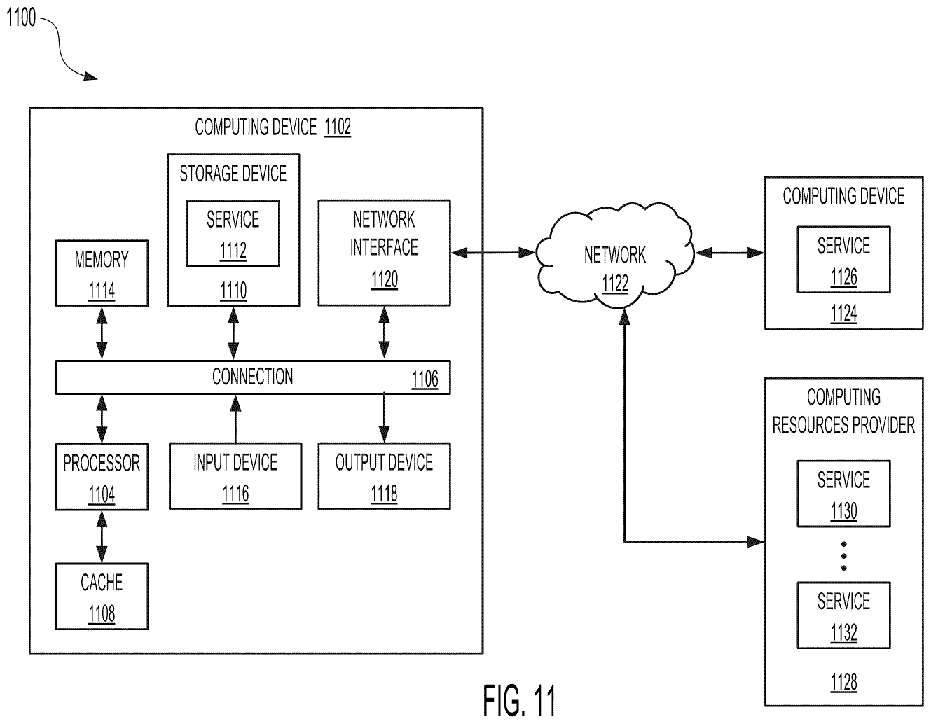

FIG. 11 illustrates a computing system architecture 1100, including various components in electrical communication with each other, in accordance with some embodiments. The example computing system architecture 1100 illustrated in FIG. 11 includes a computing device 1102, which has various components in electrical communication with each other using a connection 1106, such as a bus, in accordance with some implementations. The example computing system architecture 1100 includes a processing unit 1104 that is in electrical communication with various system components, using the connection 1106, and including the system memory 1114. In some embodiments, the system memory 1114 includes read-only memory (ROM), random-access memory (RAM), and other such memory technologies including, but not limited to, those described herein. In some embodiments, the example computing system architecture 1100 includes a cache 1108 of high-speed memory connected directly with, in close proximity to, or integrated as part of the processor 1104. The system architecture 1100 can copy data from the memory 1114 and/or the storage device 1110 to the cache 1108 for quick access by the processor 1104. In this way, the cache 1108 can provide a performance boost that decreases or eliminates processor delays in the processor 1104 due to waiting for data. Using modules, methods and services such as those described herein, the processor 1104 can be configured to perform various actions. In some embodiments, the cache 1108 may include multiple types of cache including, for example, level one (L1) and level two (L2) cache. The memory 1114 may be referred to herein as system memory or computer system memory. The memory 1114 may include, at various times, elements of an operating system, one or more applications, data associated with the operating system or the one or more applications, or other such data associated with the computing device 1102.

Other system memory 1114 can be available for use as well. The memory 1114 can include multiple different types of memory with different performance characteristics. The processor 1104 can include any general purpose processor and one or more hardware or software services, such as service 1112 stored in storage device 1110, configured to control the processor 1104 as well as a special-purpose processor where software instructions are incorporated into the actual processor design. The processor 1104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1104 can be a microprocessor, a microcontroller, a digital signal processor (“DSP”), or a combination of these and/or other types of processors. In some embodiments, the processor 1104 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1100, an input device 1116 can represent any number of input mechanisms, such as a microphone for speech, a touch-sensitive screen for gesture or graphical input, keyboard, mouse, motion input, pen, and other such input devices. An output device 1118 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1100. In some embodiments, the input device 1116 and/or the output device 1118 can be coupled to the computing device 1102 using a remote connection device such as, for example, a communication interface such as the network interface 1120 described herein. In such embodiments, the communication interface can govern and manage the input and output received from the attached input device 1116 and/or output device 1118. As may be contemplated, there is no restriction on operating on any particular hardware arrangement and accordingly the basic features here may easily be substituted for other hardware, software, or firmware arrangements as they are developed.

In some embodiments, the storage device 1110 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1110 can include hardware and/or software services such as service 1112 that can control or configure the processor 1104 to perform one or more functions including, but not limited to, the methods, processes, functions, systems, and services described herein in various embodiments. In some embodiments, the hardware or software services can be implemented as modules. As illustrated in example computing system architecture 1100, the storage device 1110 can be connected to other parts of the computing device 1102 using the system connection 1106. In an embodiment, a hardware service or hardware module such as service 1112, that performs a function can include a software component stored in a non-transitory computer-readable medium that, in connection with the necessary hardware components, such as the processor 1104, connection 1106, cache 1108, storage device 1110, memory 1114, input device 1116, output device 1118, and so forth, can carry out the functions such as those described herein.

The disclosed processes for dynamically generating virtual holograms for authentication of websites can be performed using a computing system such as the example computing system illustrated in FIG. 11, using one or more components of the example computing system architecture 1100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for implementing the virtual browser application environment described herein by, for example, executing code using a processor such as processor 1104 wherein the code is stored in memory such as memory 1114 as described herein. One or more of a user device, a provider server or system, a database system, or other such devices, services, or systems may include some or all of the components of the computing system such as the example computing system illustrated in FIG. 11, using one or more components of the example computing system architecture 1100 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1128. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1104 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1114 can be coupled to the processor 1104 by, for example, a connector such as connector 1106, or a bus. As used herein, a connector or bus such as connector 1106 is a communications system that transfers data between components within the computing device 1102 and may, in some embodiments, be used to transfer data between computing devices. The connector 1106 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1114 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1114 can also include magnetic or optical data storage media including read-only (e.g., CD ROM and DVD ROM) or otherwise (e.g., CD or DVD). The memory can be local, remote, or distributed.

As described above, the connector 1106 (or bus) can also couple the processor 1104 to the storage device 1110, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1106 can also couple the processor 1104 to a network interface device such as the network interface 1120. The interface can include one or more of a modem or other such network interfaces including, but not limited to those described herein. It will be appreciated that the network interface 1120 may be considered to be part of the computing device 1102 or may be separate from the computing device 1102. The network interface 1120 can include one or more of an analog modem, Integrated Services Digital Network (ISDN) modem, cable modem, token ring interface, satellite transmission interface, or other interfaces for coupling a computer system to other computer systems. In some embodiments, the network interface 1120 can include one or more input and/or output (I/O) devices. The I/O devices can include, by way of example but not limitation, input devices such as input device 1116 and/or output devices such as output device 1118. For example, the network interface 1120 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1102 can be connected to one or more additional computing devices such as computing device 1124 via a network 1122 using a connection such as the network interface 1120. In such embodiments, the computing device 1124 may execute one or more services 1126 to perform one or more functions under the control of, or on behalf of, programs and/or services operating on computing device 1102. In some embodiments, a computing device such as computing device 1124 may include one or more of the types of components as described in connection with computing device 1102 including, but not limited to, a processor such as processor 1104, a connection such as connection 1106, a cache such as cache 1108, a storage device such as storage device 1110, memory such as memory 1114, an input device such as input device 1116, and an output device such as output device 1118. In such embodiments, the computing device 1124 can carry out the functions such as those described herein in connection with computing device 1102. In some embodiments, the computing device 1102 can be connected to a plurality of computing devices such as computing device 1124, each of which may also be connected to a plurality of computing devices such as computing device 1124. Such an embodiment may be referred to herein as a distributed computing environment.

The network 1122 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1122 can be wired connections, wireless connections, or combinations thereof. Communications via the network 1122 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1122, within the computing device 1102, within the computing device 1124, or within the computing resources provider 1128 can include information, which also may be referred to herein as content. The information may include text, graphics, audio, video, haptics, and/or any other information that can be provided to a user of the computing device such as the computing device 1102. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1102 and presented to a user of the computing device 1102 using forms that are perceptible via sight, sound, smell, taste, touch, or other such mechanisms. In some embodiments, communications over the network 1122 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1102 and/or the computing device 1124 can be connected to a computing resources provider 1128 via the network 1122 using a network interface such as those described herein (e.g. network interface 1120). In such embodiments, one or more systems (e.g., service 1130 and service 1132) hosted within the computing resources provider 1128 (also referred to herein as within “a computing resources provider environment”) may execute one or more services to perform one or more functions under the control of, or on behalf of, programs and/or services operating on computing device 1102 and/or computing device 1124. Systems such as service 1130 and service 1132 may include one or more computing devices such as those described herein to execute computer code to perform the one or more functions under the control of, or on behalf of, programs and/or services operating on computing device 1102 and/or computing device 1124.

For example, the computing resources provider 1128 may provide a service, operating on service 1130 to store data for the computing device 1102 when, for example, the amount of data that the computing device 1102 exceeds the capacity of storage device 1110. In another example, the computing resources provider 1128 may provide a service to first instantiate a virtual machine (VM) on service 1132, use that VM to access the data stored on service 1132, perform one or more operations on that data, and provide a result of those one or more operations to the computing device 1102. Such operations (e.g., data storage and VM instantiation) may be referred to herein as operating “in the cloud,” “within a cloud computing environment,” or “within a hosted virtual machine environment,” and the computing resources provider 1128 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1128 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1130 and service 1132 may implement versions of various services (e.g., the service 1112 or the service 1126) on behalf of, or under the control of, computing device 1102 and/or computing device 1124. Such implemented versions of various services may involve one or more virtualization techniques so that, for example, it may appear to a user of computing device 1102 that the service 1112 is executing on the computing device 1102 when the service is executing on, for example, service 1130. As may also be contemplated, the various services operating within the computing resources provider 1128 environment may be distributed among various systems within the environment as well as partially distributed onto computing device 1124 and/or computing device 1102.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1102) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 7-8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1102.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
detecting a request to access a website, wherein the website is implemented on one or more web servers;
authenticating the website, wherein the website is authenticated based on a set of assets corresponding to the website;
dynamically generating a virtual hologram corresponding to the website, wherein the virtual hologram is dynamically generated according to a virtual hologram seed associated with the website and one or more parameters associated with the website;
providing the virtual hologram, wherein the virtual hologram is provided in real-time with the website, and wherein when the virtual hologram is processed by an authentication device, the authentication device verifies that the website has been authenticated;
detecting a change to the one or more parameters associated with the website; and
dynamically updating the virtual hologram corresponding to the website, wherein the virtual hologram is dynamically updated according to the virtual hologram seed and the change to the one or more parameters.

2. The computer-implemented method of claim 1, wherein providing the virtual hologram further comprises:
obtaining the set of assets, wherein the set of assets is used to implement the website; and
encoding the set of assets and the virtual hologram according to a data format to generate a data stream, wherein when the data stream is received, the data stream is decoded to generate a graphical facsimile of the website and the virtual hologram.

3. The computer-implemented method of claim 1, wherein the virtual hologram is a Quick Response code.

4. The computer-implemented method of claim 1, wherein the virtual hologram encodes a set of signal instructions that, when executed, cause a computing device to transmit a unique wireless signal, and wherein the unique wireless signal is configured according to the virtual hologram seed and the one or more parameters.

5. The computer-implemented method of claim 1, wherein the one or more parameters include a timestamp corresponding to a time when the request was detected.

6. The computer-implemented method of claim 1, wherein the virtual hologram is provided through an inline frame implemented on the website.

7. The computer-implemented method of claim 1, further comprising:
transmitting a set of executable instructions that, as a result of being executed, cause an option to inspect the virtual hologram on the website to become disabled.

8. The computer-implemented method of claim 1, wherein:
the virtual hologram encodes a set of executable instructions that, when executed by the authentication device, cause the authentication device to request authentication information for authenticating a user of the authentication device; and
the computer-implemented method further comprises dynamically generating a new virtual hologram corresponding to the authentication device, wherein the new virtual hologram is generated according to the authentication information.

9. The computer-implemented method of claim 1, further comprising:
receiving a one-time passcode associated with the virtual hologram and credential information associated with a user of the authentication device, wherein the one-time passcode is extracted from the virtual hologram; and
allowing access to one or more elements associated with the website, wherein the access is allowed based on authentication of the one-time passcode and the credential information.

10. A system, comprising:
one or more processors; and
memory storing thereon instructions that, as a result of being executed by the one or more processors, cause the system to:
detect a request to access a website, wherein the website is implemented on one or more web servers;
authenticate the website, wherein the website is authenticated based on a set of assets corresponding to the website;
dynamically generate a virtual hologram corresponding to the website, wherein the virtual hologram is dynamically generated according to a virtual hologram seed associated with the website and one or more parameters associated with the website;
provide the virtual hologram, wherein the virtual hologram is provided in real-time with the website, and wherein when the virtual hologram is processed by an authentication device, the authentication device verifies that the website has been authenticated;
detect a change to the one or more parameters associated with the website; and
dynamically update the virtual hologram corresponding to the website, wherein the virtual hologram is dynamically updated according to the virtual hologram seed and the change to the one or more parameters.

11. The system of claim 10, wherein the instructions that cause the system to provide the virtual hologram further cause the system to:
obtain the set of assets, wherein the set of assets is used to implement the website; and
encode the set of assets and the virtual hologram according to a data format to generate a data stream, wherein when the data stream is received, the data stream is decoded to generate a graphical facsimile of the website and the virtual hologram.

12. The system of claim 10, wherein the virtual hologram is a Quick Response code.

13. The system of claim 10, wherein the virtual hologram encodes a set of signal instructions that, when executed, cause a computing device to transmit a unique wireless signal, and wherein the unique wireless signal is configured according to the virtual hologram seed and the one or more parameters.

14. The system of claim 10, wherein the one or more parameters include a timestamp corresponding to a time when the request was detected.

15. The system of claim 10, wherein the virtual hologram is provided through an inline frame implemented on the website.

16. The system of claim 10, wherein the instructions further cause the system to:
transmit a set of executable instructions that, as a result of being executed, cause an option to inspect the virtual hologram on the website to become disabled.

17. The system of claim 10, wherein:
the virtual hologram encodes a set of executable instructions that, when executed by the authentication device, cause the authentication device to request authentication information for authenticating a user of the authentication device; and
the instructions further cause the system to dynamically generate a new virtual hologram corresponding to the authentication device, wherein the new virtual hologram is generated according to the authentication information.

18. The system of claim 10, wherein the instructions further cause the system to:
receive a one-time passcode associated with the virtual hologram and credential information associated with a user of the authentication device, wherein the one-time passcode is extracted from the virtual hologram; and
allow access to one or more elements associated with the website, wherein the access is allowed based on authentication of the one-time passcode and the credential information.

19. A non-transitory, computer-readable storage medium storing thereon executable instructions that, as a result of being executed by one or more processors of a computer system, cause the computer system to:
detect a request to access a website, wherein the website is implemented on one or more web servers;
authenticate the website, wherein the website is authenticated based on a set of assets corresponding to the website;
dynamically generate a virtual hologram corresponding to the website, wherein the virtual hologram is dynamically generated according to a virtual hologram seed associated with the website and one or more parameters associated with the website;
provide the virtual hologram, wherein the virtual hologram is provided in real-time with the website, and wherein when the virtual hologram is processed by an authentication device, the authentication device verifies that the website has been authenticated;
detect a change to the one or more parameters associated with the website; and
dynamically update the virtual hologram corresponding to the website, wherein the virtual hologram is dynamically updated according to the virtual hologram seed and the change to the one or more parameters.

20. The non-transitory, computer-readable storage medium of claim 19, wherein the executable instructions that cause the computer system to provide the virtual hologram further cause the computer system to:
obtain the set of assets, wherein the set of assets is used to implement the website; and
encode the set of assets and the virtual hologram according to a data format to generate a data stream, wherein when the data stream is received, the data stream is decoded to generate a graphical facsimile of the website and the virtual hologram.

21. The non-transitory, computer-readable storage medium of claim 19, wherein the virtual hologram is a Quick Response code.

22. The non-transitory, computer-readable storage medium of claim 19, wherein the virtual hologram encodes a set of signal instructions that, when executed, cause a computing device to transmit a unique wireless signal, and wherein the unique wireless signal is configured according to the virtual hologram seed and the one or more parameters.

23. The non-transitory, computer-readable storage medium of claim 19, wherein the one or more parameters include a timestamp corresponding to a time when the request was detected.

24. The non-transitory, computer-readable storage medium of claim 19, wherein the virtual hologram is provided through an inline frame implemented on the website.

25. The non-transitory, computer-readable storage medium of claim 19, wherein the executable instructions further cause the computer system to:
transmit a set of executable instructions that, as a result of being executed, cause an option to inspect the virtual hologram on the website to become disabled.

26. The non-transitory, computer-readable storage medium of claim 19, wherein:
the virtual hologram encodes a set of instructions that, when executed by the authentication device, cause the authentication device to request authentication information for authenticating a user of the authentication device; and
the executable instructions further cause the computer system to dynamically generate a new virtual hologram corresponding to the authentication device, wherein the new virtual hologram is generated according to the authentication information.

27. The non-transitory, computer-readable storage medium of claim 19, wherein the executable instructions further cause the computer system to:
receive a one-time passcode associated with the virtual hologram and credential information associated with a user of the authentication device, wherein the one-time passcode is extracted from the virtual hologram; and
allow access to one or more elements associated with the website, wherein the access is allowed based on authentication of the one-time passcode and the credential information.
